(19) United States
(12) Patent Application Publication
(10) Pub. No.: US 2010/0032295 A1
(43) Pub. Date: Feb. 11, 2010

(54) Continuous film electrophoresis

(75) Inventor: Kevin Ulmer, Cohasset, MA (US)

Correspondence Address: COOLEY GODWARD KRONISH LLP;ATTN: Patent Group, Suite 1100, 777 - 6th Street, NW, WASHINGTON, DC, 20001, US

(73) Assignee: Genome Corporation, Cohasset, MA (US)

(21) Appl. No.: 12/221,794

(22) Filed: Aug. 6, 2008

(51) Int. Cl. B01D 57/02

(52) U.S. Cl. 204/461; 204/616

(57) ABSTRACT

The present invention relates to systems for continuous film electrophoresis and processes for parallel DNA sequencing.

### TECHNICAL FIELD

The present invention relates to systems for continuous film electrophoresis and processes for parallel DNA sequencing.

### BACKGROUND

Sanger sequencing is a technique that has been used to generate most of sequence data in the world over the past 30 years, including the initial reference human genomes. Classical chain-termination, i.e., the Sanger sequencing method, involves a single-stranded DNA template, a DNA primer, a DNA polymerase, radioactively or fluorescently labeled nucleotides, and modified nucleotides that terminate DNA strand elongation. If the label is not attached to the dideoxynucleotide terminator (e.g., labeled primer), or is a “monochromatic” label (e.g., radioisotope), then the DNA sample is divided into four separate sequencing reactions, containing four standard deoxynucleotides (dATP, dGTP, dCTP and dTTP) and the DNA polymerase. To each reaction is added only one of the four dideoxynucleotides (ddATP, ddGTP, ddCTP, or ddTTP). These dideoxynucleotides are the chain-terminating nucleotides, lacking a 3′-OH group required for the formation of a phosphodiester bond between two nucleotides during DNA strand elongation. If each of the dideoxynucleotides carries a different label, however, (e.g., 4 different fluorescent dyes), then all the sequencing reactions can be carried out together without the need for separate reactions. Incorporation of a dideoxynucleotide into the nascent, i.e., elongating, DNA strand terminates DNA strand extension, resulting in a nested set of DNA fragments of varying length.

Newly synthesized and labeled DNA fragments are denatured, and separated by size using gel electrophoresis on a denaturing polyacrylamide-urea gel capable of resolving single-base differences in chain length. If each of the four DNA synthesis reactions was labeled with the same, monochromatic label (e.g., radioisotope), then they are separated in one of four individual, adjacent lanes in the gel, in which each lane in the gel is designated according to the dideoxynucleotide used in the respective reaction, i.e., gel lanes A, T, G, C. If four different labels were utilized, then the reactions can be combined in a single lane on the gel. DNA bands are then visualized by autoradiography or fluorescence, and the DNA sequence can be directly read from the X-ray film or gel image.

The terminal nucleotide base is identified according to the dideoxynucleotide that was added in the reaction resulting in that band or its corresponding direct label. The relative positions of the different bands in the gel are then used to read (from shortest to longest) the DNA sequence as indicated.

A fundamental problem with classical Sanger sequencing that has limited throughput and adds significantly to cost is a requirement to process the DNA for each read, i.e., electrophoretic separation at single-base resolution, as a discrete sample. Sanger sequencing is currently too expensive and time-consuming to address many compelling applications, and the historic rate of reduction in cost implies that Sanger sequencing will not achieve low enough cost to satisfy these demands in the near future.

Even the more modern automated capillary sequencers are limited in the number of samples they can process, for example separating only 96 reads to 384 reads per instrument cycle at approximately 1 to 2 hours per cycle. Hundreds of instruments, each costing hundreds of thousands of dollars, would need to operate continuously for many months to process, for example, tens of millions of reads.

There is a need for systems for continuous electrophoresis and processes for parallel DNA sequencing that can more rapidly analyze tens to hundreds of millions of Sanger extension products at significantly lower costs and higher throughput than prior art analysis techniques.

### SUMMARY

The invention provides methods and apparatus for efficient, high-throughput processing of sequence information using Sanger-type sequencing techniques. According to the invention, a plurality of sequencing reactions are processed simultaneously and continuously on a single gel-based film. Sequencing according to the invention occurs on a film-like electrophoresis gel. The economies of scale, speed and the automated continuous nature of sequencing methods of the invention will result in significant process advantages over traditional technologies.

An aspect of the present invention provides a continuous electrophoresis system in which a film is conveyed along a predetermined path in which one or more layers of a polymer matrix incorporating completed Sanger sequencing reactions are applied to the film by a coating apparatus. In one embodiment, the coating apparatus is a slide or cascade coating apparatus.

In another embodiment, the coating apparatus comprises a series of dies or slots each connected through a distribution channel to a reservoir of corresponding reagent, and further includes pumps that are able to dispense the polymer coatings in a metered fashion. The coating apparatus applies a defined series of layers of a first polymer matrix (sieving matrix) to a top surface of the base film to form an electrophoresis gel. Microcapsules containing nucleic acid extension products from a completed Sanger sequencing reaction are incorporated into the first polymer matrix along an edge of the film by single-file injection of the microcapsules in the laminar flow of the distribution channel for the first polymer matrix. Parallel, multiple lines of microcapsules may be incorporated into the first polymer matrix layer across the width of the base support film such that the spacing between such parallel lines is greater than or equal to the separation length used to resolve the complete sequencing reaction. Microcapsules containing completed Sanger products are taught in co-pending U.S. patent application Ser. No. ______, entitled “Microcapsules and methods of use for amplification and sequencing”, and filed on ______, incorporated by reference here. The coating apparatus further includes a laminating apparatus that applies a top film to the electrophoresis gel, completing the sandwich structure while leaving the outer edges of the electrophoresis gel exposed.

In other embodiments, the coating apparatus comprises a plurality of sequential “printing” apparatuses that apply the first polymer matrix including completed Sanger sequencing reactions and second polymer matrix (insulating top coating) on the base support film. For example, the system can include at least three printing apparatuses arranged in series and operably connected to the conveyance apparatus. Each printing apparatus comprises a pump and at least one reservoir connected to at least one nozzle, slot, or die. A first printing apparatus applies a layer of a first polymer matrix to a top surface of the base film to form an electrophoresis gel. A second printing apparatus deposits microcapsules containing nucleic acid extension products from completed Sanger sequencing reactions along an edge of the electrophoresis gel. A third printing apparatus applies a layer of a second polymer matrix (insulating top coating) to the electrophoresis gel.

A buffer reservoir is connected to the conveyance apparatus through which the film next passes, and the buffer reservoir includes at least one extended anode along one side of the reservoir adjacent to one edge of the film, and at least one extended cathode along the opposite side of the reservoir adjacent to the other edge of the film, wherein the buffer reservoir is configured such that the electrophoresis buffer is in fluid and therefore electrical contact with the outer exposed edges of the electrophoresis gel. A detection device is connected to the conveyance apparatus and records an electropherogram resulting from each of the microcapsules loaded into the electrophoresis gel being conveyed along the conveying path after emerging from the electrophoresis reservoir.

In a related embodiment of the invention, the conveyance apparatus described above utilizes conventional rollers to convey the base film along the conveying path, including non-contact rollers, “liquid bearings”, or other turning devices. In certain embodiments, a thin gas or liquid layer is employed between the roller or other turning devices and the film to prevent direct mechanical contact with the roller. In another related embodiment, a system of the invention further comprises a feeder unit with a roll support frame for supporting one or more continuous rolls of the base film, in which the feeder unit is able to splice the ends of successive rolls of the base film so as to allow continuous operation of the conveyance apparatus. A similar feeder unit is provided for the upper laminate film in other embodiments.

A system of the invention may further include an ultraviolet (UV) or similar irradiation device connected to the conveyance apparatus and located after the coating apparatus to polymerize and/or cross-link a reactive monomer solution applied to the base film being conveyed along the conveying path. In yet another related embodiment, the system further includes a high-voltage power supply electrically connected to the anode connection and cathode connection of the buffer reservoir. In other related embodiments, the system further includes both inlet and outlet connections to the electrophoresis reservoir and pumps for recirculation and replenishment of the buffer. In still further embodiments, an active thermal control system provides uniform temperature throughout the electrophoresis buffer reservoir. A system of the invention may further comprise a computer to process data obtained from the electropherograms.

Examples of materials that compose the base film include various polymers including polyesters and silicones. In certain embodiments, the polymer is poly(ethylene terephthalate). In other embodiments, the support film is a reinforced silicone elastomer. The film may either be disposable or reusable upon reconditioning.

In certain embodiments of the system, the base film is coated uniformly with a first polymer matrix layer (sieving matrix) and either laminated with a top polymer film or coated with a second polymer matrix (depending on the coating apparatus) to complete the sandwich structure. In such embodiments, the polymers chosen for the base film, top film, or second polymer matrix, and the interposed first polymer matrix are functionally compatible. The first polymer matrix wets the base film and top polymer film uniformly and the interfacial properties between the first polymer matrix and each of the base film and top film suppress electroosmotic flow (EOF), while allowing single-base resolution electrophoretic separation of Sanger extension products incorporated within the first polymer matrix along one edge of the sandwich during the coating process.

A coating apparatus capable of continuously producing such a sandwich structure includes two opposed, counter-rotating precision rollers oriented horizontally, each conveying one of the two polymer films (i.e., the base support film and the top lamination film) to the narrow, precision slot formed between the rollers. A bead of the first polymer matrix is continuously applied across the width of the slot between the films on the rollers, thereby entraining the polymer matrix between the base film and top film to create a uniform thickness electrophoresis gel. Additionally, microcapsules containing extension products of completed Sanger sequencing reactions are applied single-file by a suitable nozzle positioned at one end of the coating bead such that the microcapsules are incorporated into the first polymer matrix between the base film and the top film.

The use of simultaneous, multilayer coating technology allows for the separation and optimization of the functional requirements of each of the component layers. A first polymer matrix applied directly in contact with the base film is chosen to promote wetting of the base film for proper, uniform spreading of subsequent layers. The rheological properties and interfacial tension of this first polymer matrix are adjusted to achieve proper wetting, depending on the surface chemical properties of the base film. A second polymer matrix is applied over the first polymer matrix to reduce or eliminate electroosmotic flow (EOF). In certain embodiments, the second polymer matrix is poly(N-hydroxyethylacrylamide) (pHEA) with a molar mass of 4.0 MDa, a polydispersity index of 3.2 and a coating thickness of 100 nm to 500 nm.

In another embodiment, the first polymer matrix (sieving polymer matrix) also provides EOF suppression, eliminating the need for additional layers of a separate second polymer matrix. The preferred polymer for the first polymer matrix (sieving polymer matrix) is poly(N,N-dimethylacrylamide) (pDMA). For example, the concentration of the pDMA in the sieving polymer matrix is about 3%, about 4%, or about 5% (w/v), and the molar mass of the pDMA is about 3.4 MDa with a polydispersity index of about 1.6. In another embodiment, the first polymer matrix (sieving polymer matrix) is comprised of a blend of such high molar mass pDMA with lower molar mass pDMA (e.g., 0.28 MDa, polydispersity index 1.9) in the proportions of 3% and 2% respectively (Fredlake et al. (2008) Proc. Natl. Acad. Sci. USA 105(2):476-481, incorporated herein by reference).

In certain embodiments, the sieving polymer matrix is applied at a thickness slightly greater than or equal to the outer diameter of the incorporated microcapsules containing the completed Sanger sequencing reactions. For example, less than 100 μm in thickness, or less than 50 μm in thickness, or less than 10 μm in thickness, or less than 5 μm in thickness. Symmetrical layers of a second polymer matrix, which act as a EOF suppression polymer, and a third wetting polymer, are applied over the first polymer matrix (sieving polymer matrix). In certain embodiments, the coating apparatus applies all of these layers simultaneously using slide or cascade coating technology, capable of insuring uniform thickness (equal to or less than 2% CV) of each of the individual layers both across the width of the base film and along the length of the film. In alternative embodiments, the coating apparatus applies a gradient of the sieving polymer matrix across the width of the base film so as to make the resolved bands of the sequencing ladder more uniform in width and to thereby allow the maximum possible read length within a given width of coated film. Such gradients may include gradients in the thickness of the sieving polymer matrix or concentration gradients of the blended components of the sieving polymer matrix or of other additives known in the art, or combinations of the aforementioned.

Examples of materials that compose the top film include various polymers, including polyesters. In certain embodiments, the polymer is poly(ethylene terephthalate). The optical properties of the top film are compatible with the detection device, including optical transparency and an absence of induced fluorescence in the wavelength regions of the labels employed. Examples of the thickness of the top film include, ≦10 μm in thickness or ≦1 μm in thickness. The top film may either be disposable or reusable upon reconditioning.

Electrophoresis buffer is selected from the group consisting of: Tris-Borate-EDTA (TBE), Tris-Acetate-EDTA (TAE), or preferably 49 mM Tris, 49 mM N-(Tris(hydroxymethyl)methyl)3-aminopropanesulfonic acid, 2 mM EDTA (TTE). Low-conductivity buffers based on lithium formulations such as those sold by Faster Better Media, LLC (Hunt Valley, Md.) may also be employed.

Detection of labeled nucleic acids can be done by any conventional means or by superior methods taught in co-pending U.S. patent application Ser. No. ______, entitled “Continuous imaging of nucleic acids”, filed on ______, incorporated by reference here.

Another aspect of the invention provides a process for parallel DNA sequencing in which microcapsules containing nucleic acid extension products from completed Sanger reactions are applied to a conveyance film as described in the apparatus above.

Another aspect of the invention includes a process for parallel DNA sequencing, the process including contacting at least one individual microcapsule containing Sanger extension products from a completed Sanger reaction to an edge of an electrophoresis gel being conveyed along a conveying path, applying an insulating coating of a second polymer matrix or an upper laminated film to the electrophoresis gel being conveyed along the conveying path; contacting exposed edges of the electrophoresis gel to an electrophoresis buffer in a buffer reservoir; applying a voltage across the width of the sequencing gel while submerged in the buffer reservoir to separate the Sanger extension products as the electrophoresis gel is conveyed along the conveying path; and subsequently detecting an electropherogram of separated Sanger extension products from the electrophoresis gel being conveyed along the conveying path.

In certain embodiments of the process, prior to contacting the microcapsule to the electrophoresis gel, the process further includes applying a coating of a first polymer matrix to a base film to form the electrophoresis gel. In other embodiments, the process further includes exposing the base film and the first polymer matrix to UV irradiation to facilitate crosslinking and bonding of the first polymer matrix to the base film, as the base film and the first polymer matrix are conveyed along the conveying path.

In certain embodiments of the process, applying the coating of the first polymer matrix to the base film is performed by coating apparatuses described herein. In other embodiments, contacting the individual microcapsule to the edge of the electrophoresis gel is performed by coating apparatuses described herein. In another embodiment, applying the coating of the second insulating polymer matrix is performed by coating apparatuses as described herein.

Another aspect of the invention herein provides a method of nucleic acid sequencing, including: conducting a sequencing reaction in a microcapsule; applying the microcapsule and a first polymer matrix onto a base film to form an electrophoresis gel that is being continuously conveyed along a conveying path; conducting electrophoretic separation; and detecting results of the electrophoretic separation, thereby sequencing the nucleic acid.

### BRIEF DESCRIPTION OF THE DRAWINGS

FIG. 1 is a diagram of a multiple sheath flow device that can be used to make the microcapsules of the present invention.

FIGS. 2A and 2B are bright field and fluorescent images, respectively, of impermeable polymer shell microcapsules 6 days post-encapsulation.

FIG. 3 is a bright field image of smaller diameter impermeable polymer shell microcapsules.

FIGS. 4A-L are bright field and fluorescent images of intermediate diameter and/or thinner impermeable polymer shell microcapsules.

FIGS. 5A-D are bright field and fluorescent images of permeable polymer shell microcapsules at 5 minutes and 20 hours post-encapsulation.

FIGS. 6A-T are bright field and fluorescent images of semi-permeable polymer shell microcapsules at 5 minutes and 16 hours post encapsulation.

FIGS. 7A-F are bright field and fluorescent images of higher molecular weight cut-off semi-permeable polymer shell microcapsules.

FIG. 8A-H are bright field and fluorescent images of semi-permeable polymer shell microcapsules containing DNA.

FIG. 9A-L are bright field and fluorescent images of semi-permeable polymer shell microcapsules used for Rolling Circle Amplification of encapsulated DNA.

FIG. 10A-L are bright field and fluorescent images of Rolling Circle Amplification in alternative formulation semi-permeable polymer shell microcapsules.

FIG. 11A-D are bright field and fluorescent images demonstrating thermostability of semi-permeable polymer shell microcapsules.

FIG. 12A-F are bright field and fluorescent images demonstrating permeability of polymer shell microcapsules to dye-labeled dideoxyterminators.

### DETAILED DESCRIPTION

The invention provides a continuous film electrophoresis system. In certain embodiments, a continuous electrophoresis system of the invention comprises a feeder unit with a roll support frame for supporting a continuous roll of a base film. The feeder unit roll support frame includes at least two columnar frames and a rotary shaft positioned perpendicular to and attached to the columnar frames, such that the feeder unit roll support frame supports at least one roll of a base film, in which each of the base film rolls has a hollow tube along a central axis in a generally horizontal position such that the rolls of base film slide onto the rotary shaft.

The term “base film” as used herein refers to any suitable flexible support material for gel electrophoresis that can be spooled onto a roll or drum or similar configuration. Exemplary compositions that compose the base film include polymers and elastomers. Suitable polymer base films include continuous rolls of Mylar® (poly(ethylene terephthalate) or PET) film, commercially available from DuPont-Teijin Films (Hopewell, Va.). Advantages of PET film include low cost (approximately $0.01 to $0.02/ft²), ultra-thin, optically transparent, thermally stable, non-conductive and disposable. Other PET films suitable as a base for gel bonding include GelBond-PAG from Lonza (Basel, Switzerland). In certain embodiments, the base film is chemically modified to allow for covalent attachment of a polyacrylamide gel, which process is shown in Nochumson et al., U.S. Pat. No. 4,415,428, incorporated by reference herein.

In certain embodiments, the base film is disposable. In alternative embodiments, the base film is reusable, allowing for the use of a continuous belt, which further reduces costs. Suitable continuous belts include reinforced silicone elastomeric varieties such as those available from Specialty Silicone Fabricators, Inc. (Paso Robles, Calif.). In embodiments in which the base film is reusable, after imaging an electropherogram, the base film may be passed through one or more cleaning baths to remove the coated polymers. Such cleaning baths may include ultrasonic cleaning steps. Additionally, the belt may be exposed to an oxygen plasma to remove the remaining residue of the electrophoresis gel material from the base film and reactivate the base film for the next cycle of polymer matrix coating. Such in-line plasma cleaning devices are already widely utilized in industry and are commercially available from PVA TEPLA AMERICA (Corona, Calif.). Alternatively, the coated polymer matrix layer applied to a polymer or elastomer base film is “stripped” (i.e., physically and continuously delaminated) from the base film after imaging and prior to additional cleaning steps as outlined previously.

A system of the invention may further comprise a conveyance apparatus, for example a belt conveyor, for conveying the base film and its applied coatings along a conveying path. In a preferred embodiment, a conveyer for use in the invention comprises two or more cylindrical rotating drums, with a continuous loop of material, i.e., the coating web, which rotates about the drums. One or both of the drums are powered, moving the base film forward at a constant and precise speed. Additional rotating drums may be included in the conveying apparatus along with appropriate drive motors and feedback controls to insure uniform tension on the support film, and/or to change the direction of motion of the film along the conveyance path.

The conveyance apparatus conveys the base film along a conveying path such that the base film interacts with other components of the continuous electrophoresis system. In certain embodiments, the conveyance apparatus is connectable to the feeder unit. In alternative embodiments, the conveyance apparatus is detached from the feeder unit.

Systems of the invention further comprise one or more coaters for depositing polymers, microcapsules and other reagents on the base film. In a particularly preferred embodiment, a system includes a slide or cascade coating apparatus capable of simultaneously applying multiple, precision thickness aqueous coatings and operably connected to the conveyance apparatus (Gutoff, E. B., “Premetered Coating” IN: Cohen, E. and E. Gutoff (Eds.) “Modern Coating and Drying Technology”, Wiley-VCH, New York, 1992, Chapt. 4, incorporated by reference herein). Slide or cascade coating apparatuses and methods of coating a substrate are shown in Mercier (U.S. Pat. No. 3,627,564), incorporated by reference herein. Further slide or cascade coating apparatuses and methods of coating a substrate are shown in Timson (U.S. Pat. No. 3,749,053), Jackson (U.S. Pat. Nos. 3,928,678 and 3,993,019), Jackson et al. (U.S. Pat. Nos. 3,928,679 and 3,996,885), Bartlett (U.S. Pat. No. 4,106,437), Choinski (U.S. Pat. No. 4,143,190), Radvan et al. (U.S. Pat. Nos. 4,345,970 and 4,427,491), Pipkin (U.S. Pat. No. 4,442,144), Shirataki (U.S. Pat. No. 4,668,329), Shibata et al. (U.S. Pat. No. 5,044,305), Sartor et al. (U.S. Pat. No. 5,728,430), Maier et al. (U.S. Pat. No. 5,741,549), Sato (U.S. Pat. No. 5,851,289), Sartor et al. (U.S. Pat. No. 5,962,075), Madrzak et al. (U.S. Pat. No. 5,997,646), Kuni (U.S. Pat. No. 6,217,940), Suszynski (U.S. Pat. No. 6,699,326), McCoy et al. (U.S. Pat. No. 6,824,818), Su et al. (U.S. Pat. No. 6,824,828), and Lin et al. (U.S. Pat. No. 7,347,898).

The coating apparatus may deposit the coated layers as a curtain or a bead to the base film. Alternatively, a slot coating apparatus may be employed to apply the necessary polymer layers to the base film. Each coating apparatus includes at least one reservoir connected to at least one die or slot. For example, the coating apparatus includes a plurality of reservoirs and a plurality of dies or slots.

Further, in embodiments in which there is more than one coating apparatus, each coating apparatus maybe configured independently of the other coating apparatuses. For example, the first coating apparatus includes one or more reservoirs and a corresponding number of dies or slots, the second coating apparatus includes one or more reservoirs and a corresponding number of dies or slots, and the third coating apparatus includes one or more reservoirs and a corresponding number of dies or slots. In certain embodiments, each coating apparatus has a different configuration from the other coating apparatuses, for example a combination of slot and slide/cascade coating apparatuses. In alternative embodiments, the coating apparatuses have the same configuration.

The coating apparatus applies at least a coating of a sieving polymer matrix to the base film being conveyed along the conveying path to form an electrophoresis gel. An exemplary polymer matrix includes polyacrylamide, which is commercially available (Sigma-Aldrich, St. Louis, Mo.) and has been used for single-stranded DNA separations for DNA sequencing for at least 30 years (Sanger, F., S. Nicklen and A. R. Coulson (1977) Proc. Natl. Acad. Sci. USA 74(12):5463-5467; Maxam, A. and W. Gilbert (1977) Proc. Natl. Acad. Sci. USA 74(2):560-564 incorporated by reference herein). Another polymer matrix for single-stranded DNA separations in DNA sequencing includes agarose (U.S. Pat. No. 5,455,344 incorporated by reference herein). Methods and processes for applying a polymer matrix are described in U.S. patents by Ogawa et al. (U.S. Pat. Nos. 4,548,869; 4,548,870; 4,579,783; 4,582,868; 4,600,641; 4,657,656; 4,699,705; 4,718,998; 4,722,777; 4,737,258; 4,737,259; 4,806,434; 4,891,119; and 4,963,243) a U.S. patent by Sugihara et al. (U.S. Pat. No. 4,695,354), and a U.S. patent by Sugimoto et al. (U.S. Pat. No. 4,897,306), each of which is incorporated by reference herein. Preferred polymer systems for DNA sequencing are taught in Fredlake et al. (2008) Proc. Natl. Acad. Sci. USA 105(2):476-481.

Preferred coating technologies allow, for example, for simultaneous application of as many as 20 layers of polymer matrix in a single pass of the coating apparatus. The coating methods provide high precision tolerances, i.e., ±2%, cross web and down web on widths of up to 5 meters, and coating thicknesses of individual layers from about 50 nm to about 25 μm. Such coating apparatuses are capable of controlling fluids from about 1 cps to about 400 cps or higher and can achieve coating speeds as high as 2.5 km/min. Exemplary coating technology is available from TSE Troller (Murgenthal, Switzerland) and other similar vendors.

In certain embodiments, the coating apparatus applies a substantially uniform density of the first polymer matrix (sieving polymer matrix) to the base film. In other embodiments, the coating apparatus applies a gradient of density of the sieving polymer matrix across the width of the base film. An advantage of a gradient gel is that it provides a mechanism for packing more bases into a given separation length by making the spacing between bands more uniform across a length of a gel. Methods of manufacturing gradient gels are shown in U.S. patents by Terai et al. (U.S. Pat. Nos. 4,966,792 and 4,968,535), each of which is incorporated by reference herein, and Sambrook et al. (Molecular Cloning—A Laboratory Manual, Cold Spring Harbor Laboratory Press, Cold Spring Harbor, N.Y., vol. 2, pp. 13-47, 1989).

In certain embodiments, to facilitate grafting or bonding of the first polymer matrix (sieving polymer matrix) to the base film, the continuous electrophoresis system includes an ultraviolet (UV) irradiation device. This device is connected to conveyance apparatus and located after the sieving matrix coating apparatus. Methods of grafting or bonding of a sieving polymer matrix to the base film are shown in Uyama et al. (Journal of Applied Polymer Science, 36(5):1087-1096, 2003) and Uchida et al. (Journal of Polymer Science Part A: Polymer Chemistry, 27(2):527-537, 2003).

In an alternative embodiment, the coating apparatus comprises at least one printing apparatus that applies a spatially-defined coating of the sieving polymer matrix to the base film such that physically separated sequencing lanes are defined on the base film. The printing apparatus generates sequencing lanes that are about 50 μm to about 10 μm or about 1 μm in width, and further generates the sequencing lanes such that the lanes are separated by hydrophobic regions, i.e., lanes of unmodified PET of similar dimensions as an example.

An exemplary nozzle for the printing apparatus is an inkjet printing nozzle, i.e., a nozzle that sprays drops of material onto a surface. Printing apparatuses are commercially available from Hewlett Packard (Palo Alto, Calif.), Epson (Long Beach, Calif.), and Siemens (Princeton, N.J.).

Inkjet printing nozzles operate by three mechanisms: thermal, piezoelectric, and continuous. Thermal inkjet nozzles operate by a series of tiny electrically heated chambers. For dispensing, a pulse of current is sent through the heating elements causing a steam explosion in each heated chamber, forming a bubble that propels a droplet of polymer matrix onto a base film. The surface tension of the polymer matrix as well as the condensation pulls a further charge of polymer matrix into each chamber through a narrow channel attached to the reservoir of the printing apparatus.

Piezoelectric inkjet nozzles have piezoelectric material in a polymer matrix-filled reservoir behind each nozzle. Application of a voltage results in the piezoelectric material changing shape or size, which generates a pressure pulse in the polymer matrix forcing a droplet of polymer matrix from the nozzle.

In continuous inkjet technology, a high-pressure pump directs matrix material from a reservoir through a gunbody and a microscopic nozzle, creating a continuous stream of polymer matrix droplets. A piezoelectric crystal creates an acoustic wave as it vibrates within the gunbody and causes the stream of liquid to break into droplets at regular intervals, for example, about 64,000 to about 165,000 drops per second. The polymer matrix droplets are subjected to an electrostatic field created by a charging electrode as they form, the field being varied according to the degree of drop deflection desired. This results in a controlled, variable electrostatic charge on each droplet. Charged droplets are separated by one or more uncharged “guard droplets” to minimize electrostatic repulsion between neighboring droplets. The charged droplets pass through an electrostatic field and are directed (deflected) by electrostatic deflection plates to print on the base film. An advantages of continuous inkjet technology is the very high velocity, i.e., about 50 m/s, of the droplets, which allows for a relatively long distance between nozzle head and base film.

A second printing apparatus deposits an individual microcapsule containing Sanger extension products from a completed Sanger reaction to one end of each sequencing lane of the electrophoresis gel being conveyed along the conveying path. Because the microcapsules will be monodisperse, it is possible to eject the microcapsules from a suitable orifice single-file into the sieving polymer matrix layer. Multiple, parallel lines of microcapsules may similarly be injected into the first polymer matrix, spaced across the coated width of the base support film such that the spacing between parallel lines of microcapsules is greater than or equal to the separation length needed to fully resolve the sequencing ladder. For example, currently available coating technology is able to apply uniform coatings across a 4.6 meter wide web. If the separation length needed to fully resolve a sequencing ladder is, e.g., 0.15 meters, then as many as 30 parallel tracks of sequence data may be produced across the width of the support film in a single coating operation.

Generally, microcapsules comprise a semipermeable membrane containing one or more enzymes and a nucleic acid template. The enzymes and nucleic acid template are located within an aqueous core of the microcapsule. The semipermeable membrane of the microcapsule allows for the free exchange of low molecular weight molecules (e.g., dNTPs, fluorescently labeled ddNTPs, short primers) and reaction byproducts (e.g., pyrophosphate). The semipermeable membrane, however, prevents enzymes and nucleic acid template from exiting the aqueous core of the microcapsule. Microrocapsules are useful for enzyme-mediated reactions such as a polymerase-mediated reaction. For instance, a thermostable microcapsule comprises a semipermeable membrane, an aqueous core, one or more polymerases in the aqueous core, and a nucleic acid template in the aqueous core. Microcapsules may be any appropriate shape or size, but a preferred microcapsule is spherical and approximately 1-10 μm in diameter.

Microcapsules are thermostable and capable of withstanding thermocycling for PCR. By “thermostable”, it is meant that the microcapsule can withstand high temperatures such as those required to denature nucleic acids. Microcapsules are capable of withstanding high-speed flow sorting, for instance, sorting at greater than about 70,000/second. A collection of microcapsules is preferably of relative uniform size, i.e., are monodisperse, and have a diameter with a coefficient of variation of less than or about 10%.

Ideally, the semipermeable membrane of the microcapsule is impermeable to high molecular weight molecules. On the other hand, the semipermeable membrane is permeable to low molecular weight molecules such as low molecular weight reagents. For instance, the semipermeable membrane can be permeable to molecules possessing a molecular weight of less than or about 20,000 g/mol, less than or about 10,000 g/mol, less than or about 5,000 g/mol, or less than or about 3,000 g/mol. Alternatively, the semipermeable membrane is impermeable to enzymes and nucleic acids that are longer than about 70 nucleotides in length. For instance, the semipermeable membrane is impermeable to the nucleic acid template contained within the aqueous core of the microcapsule.

The semipermeable membrane of the microcapsule is permeable to small molecular weight reagents and reaction byproducts. Thus, in sequencing, the semipermeable membrane is permeable to deoxynucleotide triphosphates (dNTPs), dideoxynucleotide triphosphates (ddNTPs), labeled ddNTPs, labels and dyes, pyrophosphates, divalent cations (e.g., magnesium ions and manganese ions), monovalent cations (e.g., potassium ions), and nucleic acids that are shorter than about 70 nucleotides in length.

The semipermeable membrane can comprise any polymer known in the art that is permeable to low molecular weight reagents and impermeable to high molecular weight reagents. It is important that the polymer not prevent an enzymatic reaction from occurring in the aqueous core of the microcapsule. Polymers that can be used, include, but are not limited to, acrylic polymers including, but not limited to crosslinked polyacrylamide, cyanoacrylate, diacrylates including poly(ethylene glycol) diacrylate (PEG-DA) and poly(ethylene glycol) dimethylacrylate (PEG-DMA) of various chain lengths. The semipermeable membrane can also comprise, for instance, epoxy resins including DuPont's “Somos 6100” series of resins. Porogens, such as various chain length poly(ethylene glycol)s can also be included to adjust the molecular weight cut off (MWCO) of the polymer shell of the microcapsules.

The semipermeable membrane can comprise a polymer that is capable of cross-linking to control the stability and MWCO of the microcapsule. In one embodiment of the invention, the polymer is a photocrosslinkable polymer.

The nucleic acid template within the aqueous core of each microcapsule serves as a substrate for the enzyme-mediated reaction. In one embodiment, there is a single nucleic acid template, i.e., one molecule, in each microcapsule. For instance, the microcapsule comprises a semipermeable membrane, an aqueous core, one or more polymerase enzymes in the aqueous core, and one nucleic acid template in the aqueous core. In another embodiment, the microcapsule contains multiple copies of a single nucleic acid template.

The nucleic acid template can be either a DNA template or an RNA template, including genomic DNA, cDNA, mRNA, rRNA, tRNA, gRNA, siRNA, microRNA, and others known in the art.

Although the nucleic acid template may be derived from a clone, it is unnecessary to clone the nucleic acid molecule in vivo prior to use in the microcapsule of the present invention. For instance, sheared or enzymatically digested genomic nucleic acids may be used as nucleic acid templates.

The nucleic acid template can vary in length so long as it is of sufficient size to prevent it from crossing the semipermeable membrane. For instance, the nucleic acid template can be about or greater than 100 nucleotides in length, about or greater than 200 nucleotides in length, about or greater than 300 nucleotides in length, about or greater than 400 nucleotides in length, about or greater than 500 nucleotides in length, about or greater than 600 nucleotides in length, about or greater than 700 nucleotides in length, about or greater than 800 nucleotides in length, about or greater than 900 nucleotides in length, about or greater than 1000 nucleotides in length, about or greater than 1100 nucleotides in length, or about or greater than 1200 nucleotides in length. The invention includes microcapsules comprising a nucleic acid template that is at least about 100 nucleotides in length, at least about 200 nucleotides in length, at least about 300 nucleotides in length, at least about 400 nucleotides in length, at least about 500 nucleotides in length, at least about 600 nucleotides in length, at least about 700 nucleotides in length, at least about 800 nucleotides in length, at least about 900 nucleotides in length, at least about 1000 nucleotides in length, at least about 2000 nucleotides in length, at least about 3000 nucleotides in length, at least about 4000 nucleotides in length, or at least about 5000 nucleotides in length.

The nucleic acid template may be either linear or circular, the circular topology having the added benefit of a reduced tendency to penetrate the polymer shell of the microcapsule.

The nucleic acid template should also contain at least one priming site for hybridization of a complementary primer oligonucleotide for DNA amplification.

The nucleic acid template may be single-stranded or double-stranded although the preferred template is single-stranded.

Microcapsules comprise one or more enzymes in the aqueous core. Examples of enzymes include nucleic acid modifying enzymes such as polymerases, reverse transcriptases, ligases, topoisomerases, Klenow fragment and restriction endonucleases. Examples also include thermophilic DNA polymerases, such as Taq polymerase DNA polymerase I, DNA polymerase II, DNA polymerase III holoenzyme, DNA polymerase IV, terminal transferase, Klenow fragment, T4 DNA polymerase, T7 DNA polymerase, BST DNA polymerase, and phi29 DNA polymerase. Additional examples of enzymes include various forms of “hot start” polymerases that are inactive at low temperatures (e.g., 40° C.) and only become active upon heating to relatively high temperatures (e.g., >90° C.).

In another embodiment, the enzymes are selected from a group of RNA polymerases, including, but not limited to, RNA polymerase I, RNA polymerase II, RNA polymerase III, and T7 RNA polymerase.

Microcapsules are permeable to low molecular weight reagents and buffers. Microcapsules further comprise one or more low molecular weight reagents. For example, the aqueous core is a buffer solution. Microcapsules can be stored or incubated in a solution comprising low molecular weight reagents and/or a buffer solution. Examples of low molecular weight reagents are described throughout this application and include dNTPs, ddNTPs, labeled ddNTPs (e.g., fluorescently labeled ddNTPs), divalent cations, monovalent cations, stabilizers and nucleic acid primers.

In one embodiment, the primers are able to pass through the semipermeable membrane of the microcapsule. Such primers can be up to about 70 nucleotides in length. For instance, primers that are about 5 to 10 nucleotides in length, 10 to 15 nucleotide's in length, 10 to 20 nucleotides in length, 10 to 30 nucleotides in length, 15 to 25 nucleotides in length, or 25 to 30 nucleotides in length can be used with the microcapsule of the invention as well as primers that are about 40 or fewer nucleotides in length, about 50 or fewer nucleotides in length, about 60 or fewer nucleotides in length, and about 70 or fewer nucleotides in length. In one embodiment of the invention, the primers are about 20 to 50 nucleotides in length.

In another embodiment, each microcapsule contains one or more primers that are unable to diffuse out of the aqueous core due to size. As can be appreciated by a skilled artisan, the size of the primers can vary depending on the polymer used as a semipermeable membrane. However, generally, primers greater than about 70 nucleotides are unable to cross the semipermeable membrane of the microcapsule.

The primers are substantially complementary or perfectly complementary to a region of the nucleic acid template. In one embodiment, the primer contains a small number of mismatches compared to the nucleic acid template that do not interfere with the ability of the primer to anneal to the nucleic acid template under stringent conditions. Such a primer may contain 5 or fewer, 4 or fewer, 3 or fewer, 2 or fewer, or 1 mismatches compared to the nucleic acid template.

Universal primers can be used to hybridize with a common motif in the template. For example, the primer can be a poly-T primer that is capable of binding to a poly-A region in a template nucleic acid. Random primers are, of course, also useful.

The amplification reaction can be a PCR reaction (including rtPCR and others as described below) or can be another type of amplification, such as rolling circle amplification (RCA). Rolling circle amplification is described in U.S. Pat. Nos. 6,576,448; 6,977,153; and 6,287,824, each of which is incorporated by reference herein.

Microcapsules of the invention can be made by methods known in the art for forming membrane-enclosed microcapsules, including, but not limited to, methods currently used for the microencapsulation of drugs and the like. In one embodiment of the invention, microcapsules are formed using a multiple sheath flow device as disclosed in co-pending U.S. patent application Ser. No. ______, entitled, “Methods of using a multiple sheath flow device for the production of microcapsules”, filed ______, incorporated by reference herein, which discloses a multiple sheath flow device. The device can be machined from PEEK and have three Upchurch (Oak Harbor, Wash.) inert capillary tubing inlet connections that carry: (a) an innermost liquid flow containing diluted nucleic acid templates and one or more enzymes to be incorporated into the microcapsules, (b) a coaxial flow of immiscible, semipermeable membrane forming material surrounding the inner core, and (c) an outer coaxial flow of a third solution or gas used to entrain microcapsules. The three coaxial fluids emerge through an aperture, for instance, through a precision sapphire aperture, as a liquid jet. The relative flow rates of the three fluid feeds can be adjusted to control the diameter of the microcapsules formed. The device can be operated at high pressure, using computer-controlled syringe pumps, to increase the rate of microcapsule formation and to minimize reagent consumption. The design of such a device can be modified to incorporate multiple apertures to further increase microcapsule output.

As can be appreciated by a skilled artisan, various nucleic acid amplification methods known in the art that employ an enzyme-mediated reaction can be easily modified for use with the present invention. The only requirement is that the one or more enzymes, nucleic acid template to be amplified, and, optionally, primers, be encapsulated within the semipermeable membrane of the microcapsule. For instance, in addition to polymerase chain reaction (PCR), other known amplifications methods such as rolling circle amplification (RCA), ligase chain reaction (European application EP 320 308), gap filling ligase chain reaction (U.S. Pat. No. 5,427,930), strand displacement amplification (U.S. Pat. No. 5,744,311) and repair chain reaction amplification (WO 90/01069) may be performed using the microcapsules as disclosed herein.

In one embodiment, microcapsules are used to amplify a nucleic acid template by polymerase chain reaction. In this case, the microcapsule contains a thermostable DNA polymerase (e.g., Taq polymerase) and a nucleic acid template for amplification. Preferably, the aqueous core and liquid surrounding the microcapsule contain a PCR buffer solution and dNTPs. Primers that are complementary to the nucleic acid template may be located within the aqueous core or, if capable of traversing the semipermeable membrane, in the PCR buffer solution bathing the microcapsule.

To perform PCR, one to over a billion microcapsules are placed in a tube with the appropriate PCR reagents. As with traditional PCR, the tube is placed in a thermocycler under conditions necessary for PCR (i.e., cycles of denaturation, annealing, and elongation). Briefly, in a thermocycler, the microcapsules are denatured by heating (e.g., 94° C. to 98° C.) for about 20 to 30 seconds. The microcapsules are then subjected to an annealing temperature (e.g., about 50° C. to 65° C.) for about 20 to 40 seconds. Elongation proceeds next. The elongation temperature (usually about 72° C. to 80° C.) and time (about 1,000 bases/minute) required for the elongation step depend on the polymerase enzyme used and length of nucleic acid template, respectively. The denaturation, annealing, and elongation steps are repeated several times (usually about 20 to 30 cycles) and may be capped off with an extended elongation step.

One or multiple nucleic acid templates may be amplified in a single reaction using one or a plurality of microcapsules. In one embodiment of the invention, each microcapsule contains multiple nucleic acid templates that are amplified by PCR (i.e., multiplex PCR). In a preferred embodiment of the invention, each microcapsule contains a single nucleic acid template that is amplified by PCR. In another preferred embodiment, billions of microcapsules, each microcapsule containing a single nucleic acid template, are amplified by PCR.

In a preferred embodiment, microcapsules are used to amplify a nucleic acid template by rolling circle amplification (RCA). In this case, the microcapsule contains a strand displacement DNA polymerase (e.g., phi29 polymerase) and a circular nucleic acid template for amplification. Preferably, the aqueous core and liquid surrounding the microcapsule contain a RCA buffer solution and dNTPs. A primer that is complementary to the circular nucleic acid template may be located within the aqueous core or, if the capable of traversing the semipermeable membrane, in the RCA buffer solution bathing the microcapsule.

To perform RCA, one to over a billion microcapsules are placed in a tube with the appropriate RCA reagents. Isothermal amplification (e.g., 40° C.) of the circular template results in a linear concatarner of very high molecular weight that does not cross the polymer membrane of the capsule. Microcapsules can also be used in reverse transcriptase amplification reactions. In this embodiment of the invention, each microcapsule comprises a semipermeable membrane, an aqueous core, a reverse transcriptase and an RNA template for amplification.

In one embodiment of the invention, a starting nucleic acid template is amplified within a microcapsule as described above prior to sequencing. Although not necessary, one or more microcapsules that have previously been subjected to an amplification reaction can be “cleaned-up” prior to sequencing by dialyzing against a suitable buffer.

In one embodiment, microcapsules that have previously undergone amplification are used in a Sanger sequencing reaction. Depending on the number of templates to be sequenced, one to thousands, even millions or billions, of microcapsules are placed in a tube with sequencing reagents. Sequencing reagents include dNTPs, ddNTPs and primers. Preferably, the ddNTPs are fluorescently labeled so that all four ddNTPs can be incorporated into the growing DNA chain in a single reaction.

Depending on the desired read length of the sequencing reaction (e.g., 1,000 bases) and the sensitivity requirements of the fluorescence detection system (e.g., 1,000 labeled fragments per band), then the total number of Sanger extension products can be estimated (e.g., 1,000×1,000=1 million). If the initial single molecule template in each capsule has already been amplified to an equivalent number of copies (e.g., 1 million), then only a single cycle of polymerase extension and ddNTP termination will be required to produce the required number of Sanger extension products. If, however, the initial single molecule template in each microcapsule has been amplified to a lesser extent, then multiple cycles of polymerase extension and ddNTP termination can be employed using cycle sequencing to generate the necessary number of extension products. Cycle sequencing is performed in a thermocycler by methods known in the art.

Upon completion of the sequencing reaction, it is preferable that unincorporated ddNTPs, dNTPs primers and pyrophosphates are removed. In one embodiment of the invention, unwanted reagents and byproducts are removed by dialysis against a suitable buffer.

In one embodiment of the invention, it is preferred that each microcapsule contains a single starting nucleic acid template. Poisson statistics dictate the dilution requirements needed to insure that each microcapsule contains only a single starting nucleic acid template. For example, if, on average, each microcapsule is to contain only a single template, about ⅓ of the microcapsules will be empty and contain no nucleic acid template, about ⅓ will contain exactly one nucleic acid template, and about ⅓ will contain two or more templates.

The microcapsule population may be enriched to maximize the fraction that started with a single nucleic acid template. Because the Sanger sequencing reaction incorporates fluorescently labeled ddNTPs, it is possible to flow sort the microcapsules after sequencing (and, preferably, after a purification step) to enrich for those that are fluorescent rather than empty. High speed flow sorters, such as the MoFlo™ (Beckman-Coulter, Inc., Fullerton, Calif.), are capable of sorting at rates in excess of 70,000 per second and can be used to enrich a population of microcapsules of the invention. Similarly, it is possible to exploit other differences between empty and full microcapsules (e.g., buoyant density) to enrich a population of microcapsules. In order to enrich for microcapsules with one starting nucleic acid template as opposed to several different starting templates, it may be desirable to skew the Poisson distribution accordingly.

The coating apparatus as disclosed herein is able to apply all of the microcapsules, both empty and containing Sanger extension products from a completed Sanger reaction. Thus the empty microcapsules may serve as spacers between adjacent sequencing lanes in the electrophoresis gel. Poisson statistics are adjustable to yield the proper balance between wasting lanes in the electrophoresis gel with no sequencing products and overcrowding of the gel such that the resulting sequencing ladders overlap too frequently.

In an alternative embodiment, a coating apparatus applies an immiscible liquid or polymer film over the sequencing gel layers in lieu of the upper film lamination. Silicone heat transfer liquid (commercially available from Dow Corning, Midland, Mich.) is an example of such a coating material. The silicone liquid provides a lid for the sequencing channels, similar to the second glass plate in conventional slab gel electrophoresis, providing a non-conductive, insulating barrier for evaporative loss from the gel and removing the need for a solid film barrier.

The electrophoresis gel film containing the microcapsules is then conveyed along the conveying path to the buffer reservoir of the continuous electrophoresis system. The buffer reservoir includes at least one extended anode along one side of the reservoir adjacent to one edge of the film, and at least one extended cathode along the opposite side of the reservoir adjacent to the other edge of the film, wherein the buffer reservoir is configured such that the electrophoresis buffer is in fluid and therefore electrical contact with the outer exposed edges of the electrophoresis gel. Additionally, the buffer reservoir includes at least one anode connection, and at least one cathode connection. A high-voltage source is connected to the at least one anode connection, and the at least one cathode connection. Suitable high-voltage sources for gel electrophoresis are commercially available from American High Voltage (Elko, Nev.). The buffer reservoir is configured such that the electrophoresis buffer is in fluid, and therefore electrical, contact with the exposed edges of the electrophoresis gel, allowing electrophoretic separation of the Sanger extension products during the time that the sequencing gel film is immersed in the buffer reservoir as it is continuously transported through the sequencing system by the conveying means. Exemplary running buffers include, Tris-Borate-EDTA (TBE), Tris-Acetate-EDTA (TAE), or preferably 49 mM Tris, 49 mM N-(Tris(hydroxymethyl)methyl)3-aminopropanesulfonic acid, 2 mM EDTA (TTE).

In other embodiments, the electrophoresis buffer is a low conductivity buffer, such as those commercially available from Lonza (Walkersville, Md.) or Faster Better Media, LLC (Hunt Valley, Md.). The low conductivity buffer reduces the Joule heating generated by the continuous electrophoresis system during electrophoretic separation of the Sanger extension products.

In certain embodiments of the continuous electrophoresis system, an inlet reservoir contains a supply of fresh electrophoresis buffer and provides an off-line source of buffer for electrophoretic separation of the Sanger extension products. Thus the continuous electrophoresis system does not need to be shutdown to refill the buffer reservoir, increasing efficiency and cycle time. In other embodiments, the continuous electrophoresis system includes a waste reservoir connected to the outlet valve of the buffer reservoir. The waste reservoir receives the exhausted running buffer from the buffer reservoir that has been used for electrophoretic separation of the Sanger extension products. The waste reservoir is exchanged off-line, and thus used buffer is removed without disrupting the continuous process of separation of Sanger extension products. In yet other related embodiments, the system further includes both inlet and outlet connections to the electrophoresis reservoir and appropriate pumping means for recirculation of the buffer to extend its useful lifetime. Active temperature control of the electrophoresis bath is facilitated by use of such a recirculating buffer system.

In certain embodiments, the buffer reservoir is a shallow, linear trough or similar design through which the gel film is transported by the conveying means and wherein electrophoresis is carried out as with a conventional “submarine” gel in which electrophoresis buffer covers the upper surface of the gel. In such configurations, the length of the buffer reservoir is determined by the residence time necessary to fully resolve the Sanger sequencing ladder and the linear transport speed of the conveying means. In order to reduce the linear dimensions of the electrophoresis bath, folded transport path designs may be employed. In such configurations, the sequencing gel film is transported in a serpentine pathway through the electrophoresis bath, significantly reducing its horizontal length while increasing its vertical depth. Turning means for folding the transport path of the gel film are well known in the art, including simple rollers or more complex designs employing non-contact turning means involving “liquid bearings” and the like (see, for example, U.S. Pat. No. 5,353,979 entitled, “Directing apparatus for guiding, deflecting and/or diverting a web of material”; U.S. Pat. No. 5,525,751 entitled, “System for moving a submerged web”; and U.S. Pat. No. 6,991,717 entitled “Web processing method and apparatus”, all incorporated by reference herein). Appropriate design and use of such turning means also provides for significantly reduced cross sectional area of the electrophoresis buffer with concomitant reduction in the Joule heating and simplified thermal management of the temperature uniformity throughout the electrophoresis bath.

The electrophoresis is run until the Sanger extension products are fully resolved. For example, electrophoretic separation of the Sanger extension products within the electrophoresis gel film resolves hundreds of bases in a few minutes or less. Upon full resolution of the Sanger extension products in the electrophoresis gel film, the film emerges from the buffer reservoir and is conveyed along the conveying path to the detection device to record an electropherogram, i.e., a plot of fluorescence intensity as a function of lateral position across the width of the gel film. The data are a series of colored peaks in which each peak represents one of the four labeled dideoxynucleotides.

The detection system may employ any of several imaging methods including point scanning, line scanning and array scanning, depending on the throughput requirements. Further, the use of multiple point, line or area detectors and their corresponding fluorescence excitation sources in parallel is made possible because the system of the present invention removes the constraint of real-time imaging of migrating bands during electrophoresis. Options for detection of labeled Sanger DNA fragments by such conventional means or by superior methods are taught in co-pending U.S. patent application Ser. No. ______, entitled “Continuous imaging of nucleic acids”, filed on ______, incorporated by reference here.

The continuous electrophoresis system operates using four-color imaging of a single read per microcapsule, or eight-color imaging for reads from both ends of defined fragment lengths (“mate-pairs”) to be obtained from a single microcapsule, or sixteen-color imaging for reads of complementary strands of both ends of mate-pairs to be read from the same microcapsule. Since the imaging is not coupled in real time with the electrophoresis, but performed in series after the electrophoresis is completed, additional color channels can simply be added sequentially to the conveyance means as needed.

In certain embodiments, at least one computer is operably connected to the continuous electrophoresis system. The computer includes software that commands and controls the continuous electrophoresis system. For example, the computer includes software such that the computer operates as a programmable logic controller (PLC) that electronically controls interactions of the conveyance apparatus, coating and/or printing apparatuses, laminating apparatus, electrophoresis buffer reservoir, high-voltage power supply, and detection device with the base film being conveyed along the conveying path. A PLC and PLC software are commercially available from Rockwell Automation Allen-Bradley & Rockwell Software Brands (Milwaukee, Wis.).

The computer further includes software for processing the image data to yield mobility corrected electropherograms. For those embodiments where the sieving matrix layer in the gel film is continuous, it is necessary to employ edge detection algorithms as an initial step in the image processing to identify and track individual lanes (i.e., reads) of sequence data, corresponding to individual microcapsules, across the width of the gel film. For those embodiments where discrete, physically separated lanes of sieving matrix have been printed or similarly fashioned, the tracking of individual lanes of sequence data corresponding to individual microcapsules containing Sanger extension products is simplified. The image processing software produces multidimensional quality scores for each called base that can be exploited by the assembler. An exemplary base calling program is shown in Ewing, B. and P. Green (1998) Genome Research 8:186-194; Ewing, B. et al. (1998) Genome Research 8:175-185. The continuous electrophoresis system can be configured such that operating software and data processing software are installed on a single computer. Alternatively, the continuous electrophoresis system can be configured such that the operating software is installed on one computer and the data processing software is installed on a different computer. In other configurations, much of the image processing can be carried out by special purpose logic circuitry (i.e., hardware) that is part of the imaging system, rather than in software.

Another aspect of the invention includes a process for parallel DNA sequencing, the process including contacting at least one individual microcapsule containing Sanger extension products from a completed Sanger reaction to an edge of an electrophoresis gel being conveyed along a conveying path, and applying a coating of a second polymer matrix (insulating top coating) to the electrophoresis gel being conveyed along the conveying path; contacting exposed edges of the electrophoresis gel to an electrophoresis buffer in a buffer reservoir and applying a high voltage across the width of the sequencing gel layer to separate the Sanger extension products as the electrophoresis gel is conveyed along the conveying path; and detecting an electropherogram of separated Sanger extension products from the electrophoresis gel being conveyed along the conveying path.

In certain embodiments of the process, prior to contacting the microcapsule to the electrophoresis gel, the process further includes applying a coating of a first polymer matrix to a base film to form the electrophoresis gel. In other embodiments, the process further includes exposing the base film and the first polymer matrix to UV irradiation to facilitate bonding of the first polymer matrix to the base film, as the base film and the first polymer matrix are conveyed along the conveying path.

In certain embodiments of the process, applying the coating of the first polymer matrix to the base film is performed by the first printing apparatus described herein. In other embodiments, contacting the individual microcapsule to the edge of the electrophoresis gel is performed by the second printing apparatus described herein. In another embodiment, applying the second polymer matrix (insulating top coating) is performed by the third printing apparatus as described herein.

The invention having now been described, it is further illustrated by the following examples and claims, which are illustrative and are not meant to be further limiting. Those skilled in the art will recognize or be able to ascertain using no more than routine experimentation, numerous equivalents to the specific systems and processes described herein. Such equivalents are within the scope of the present invention and claims. The contents of all references, including issued patents and published patent applications cited throughout this application, are hereby incorporated by reference in their entirety.

### EXAMPLES

### Example 1

The following example demonstrates an embodiment of the manufacture and use of microcapsules according to the invention.

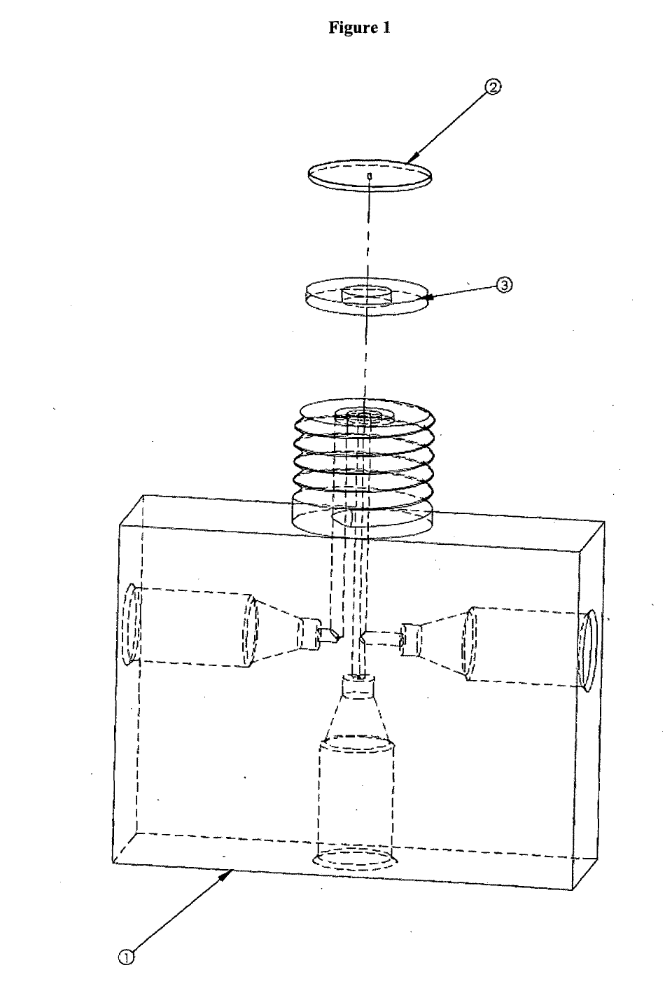

Three model NE500 syringe pumps (New Era Pump Systems, Inc., Wantagh, N.Y.) controlled by a PC running WinPumpControl software (Open Cage Software, Inc., Huntington, N.Y.) deliver fluids to the flow focusing nozzle inlet fittings illustrated in FIG. 1. An appropriately sized Luer-Lok® syringe is mounted on each pump and connected to the flow focusing nozzle by PEEK capillary tubing (Upchurch Scientific, Oak Harbor, Wash.). The pinhole aperture in the flow focusing nozzle is a model RB 22824 sapphire orifice (Bird Precision, Inc., Waltham, Mass.). The cylindrical portion of the orifice is 235 μm in diameter and 533 μm long. The innermost flow focusing tube delivering the Core Solution to be encapsulated is made of PEEK with an ID of 150 μm and an OD of 360 μm. This innermost tube is centered in a second PEEK capillary tube with an ID of 762 μm and an OD of 1587 μm, delivering the Polymer Shell Solution as a surrounding coaxial flow through the annular gap between the tubes. The exit end of the innermost tube is recessed by 500 μm from the exit tip of the surrounding tube, which is positioned at a height of 500 μm and centered on the orifice. The Focusing Solution is provided as a third coaxial flow through the annular gap between the machined body of the flow focusing nozzle and the outer capillary tube.

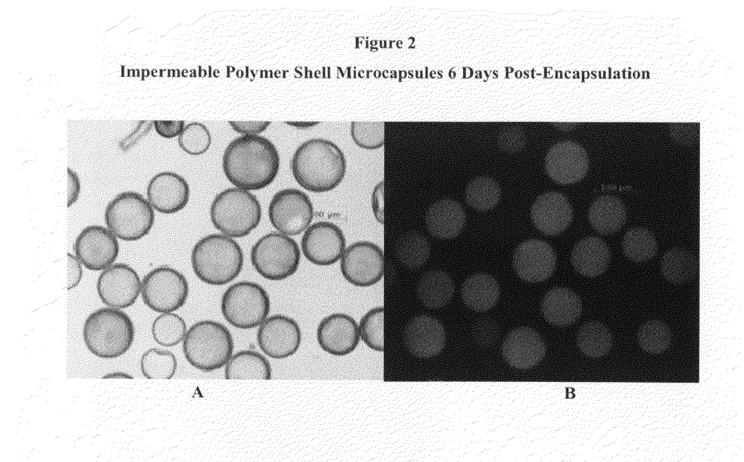

To form impermeable polymer shell microcapsules, the following three solutions were delivered to the flow focusing nozzle at the indicated volumetric flow rates: (1) Core Solution—sodium fluorescein (5 mg/mL—Fluka/Sigma-Aldrich, St. Louis, Mo.), glycerin (25% v/v—Walgreens, Deerfield, Ill.) in distilled water at 0.1 mL min⁻¹; (2) Polymer Shell Solution—PEGDMA 200 (polyethylene glycol 200 dimethacrylate) (Monomer-Polymer & Dajak Labs, Inc., Feasterville, Pa.), 4.76% v/v 2-hydroxy-2-methyl propiophenone (Sigma-Aldrich, St. Louis, Mo.), 0.4% v/v TEMED (N,N,N′,N′-tetramethylethylenediamine) and 0.05 g/mL 2,2-dimethoxy-2-phenyl-acetophenone (Sigma-Aldrich, St. Louis, Mo.) at 0.15 ml min⁻¹; and (3) Focusing Fluid—1% poly(vinyl alcohol) 87-89% hydrolyzed (Typical M_{w} 85,000-124,000) (Sigma-Aldrich, St. Louis, Mo.) in distilled water at 6.5 mL min⁻¹. The orifice of the flow focusing nozzle is positioned ˜15 cm above the liquid surface of a 1.00 mL beaker containing 50 mL of the Focusing Fluid to collect the microcapsules. The beaker sits on a near-UV transilluminator (Spectroline Slimline™ Series 365-8 W, Spectronics Corporation, Westbury, N.Y.) to provide 360 nm illumination for photoinitiation. In addition, two 40 W “black light” fluorescent lamps (GE F40BLB—General Electric Company, Fairfield, Conn.) are positioned ˜10 cm to the side of the emerging liquid jet to photoinitiate polymerization of the shell of the microcapsule prior to “splash down” in the collection beaker. Aliquots (35 μL) of microcapsules are mounted on a microscope slide and examined in an Axiovert 25 inverted microscope (Carl Zeiss MicroImaging, Inc., Thornwood, N.Y.). Digital images are captured using an AxioCam CCD camera (Carl Zeiss MicroImaging, Inc., Thornwood, N.Y.) and analyzed using AxioVision software Ver 4.6 (Carl Zeiss MicroImaging, Inc., Thornwood, N.Y.). Fluorescence imaging employs a 50 W Hg lamp illuminator (Carl Zeiss MicroImaging, Inc., Thornwood, N.Y.) and a FITC filter cube (484 nm excitation, 494/521 nm emission) (Carl Zeiss MicroImaging, Inc., Thornwood, N.Y.). Example bright field and fluorescence images of impermeable polymer shell microcapsules generated using the above described system are provided in FIGS. 2A and 2B. Encapsulation efficiency of the fluorescein labeled Core Solution is estimated at 99% with a mean microcapsule diameter of 90 μm ±15 μm and a shell thickness of 5 μm. Microcapsule formation rate is estimated at ˜11,000 sec⁻¹. Microcapsules examined immediately after polymerization are indistinguishable from those placed in distilled water for up to several weeks at room temperature, indicating no loss of fluorescein. The polymer shells of these microcapsules are therefore impermeable to fluorescein (M_{R} 376).

### Example 2

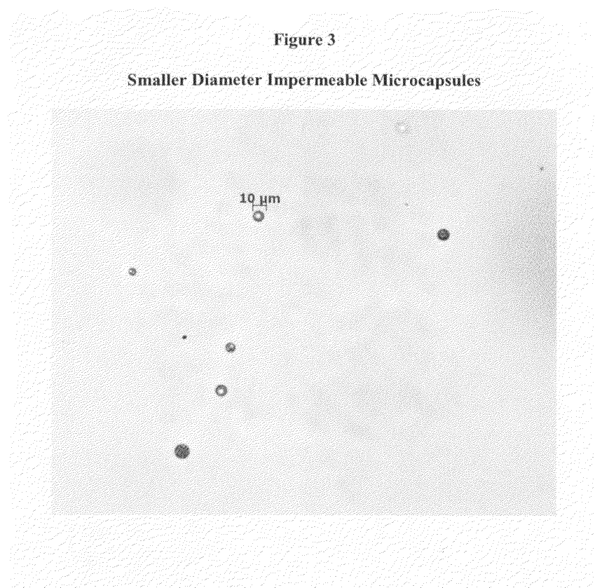

Smaller diameter impermeable polymer shell microcapsules are generated by adjusting the relative flow rates of the solutions from Example 1 as follows: Core Solution—0.025 ml min⁻¹; Polymer Shell Solution—0.05 ml min⁻¹; and Focusing Fluid—6.0 ml min⁻¹. The resulting microcapsules, illustrated in FIG. 3, are <10 μm in diameter.

### Example 3

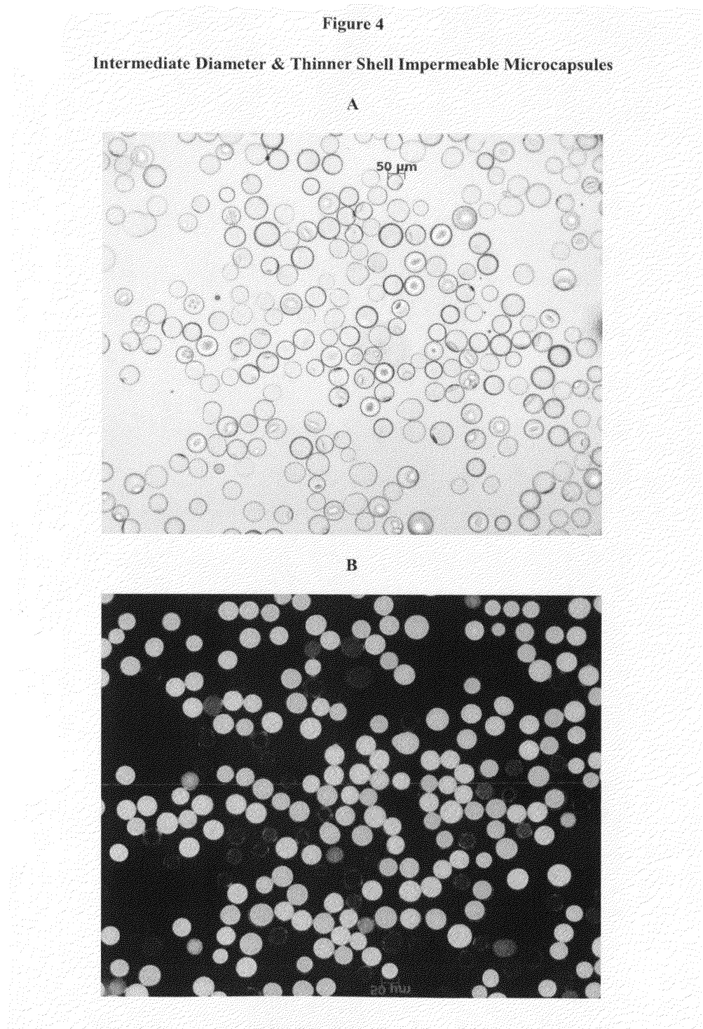

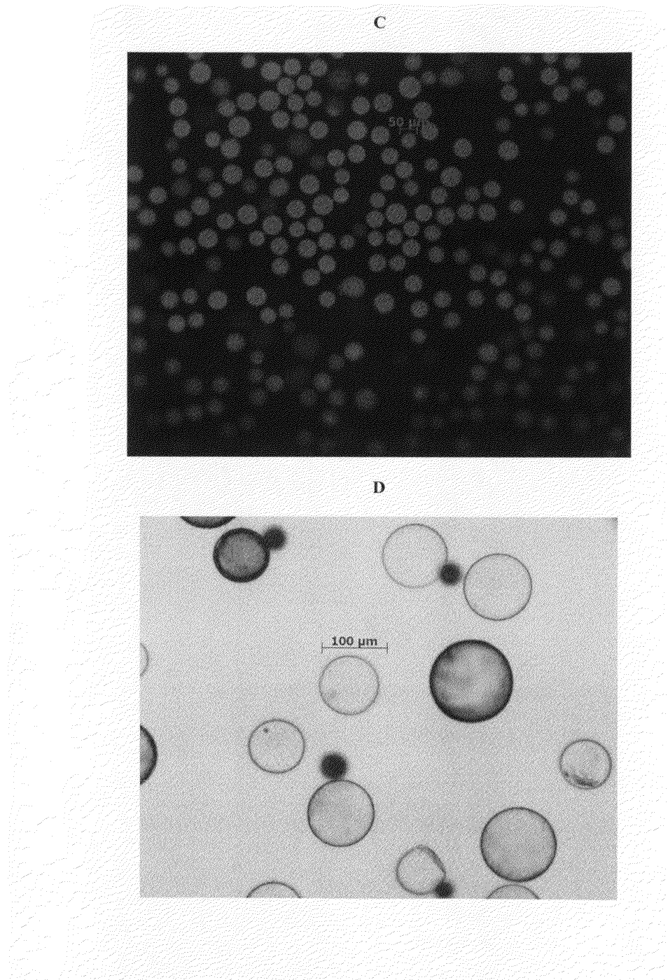

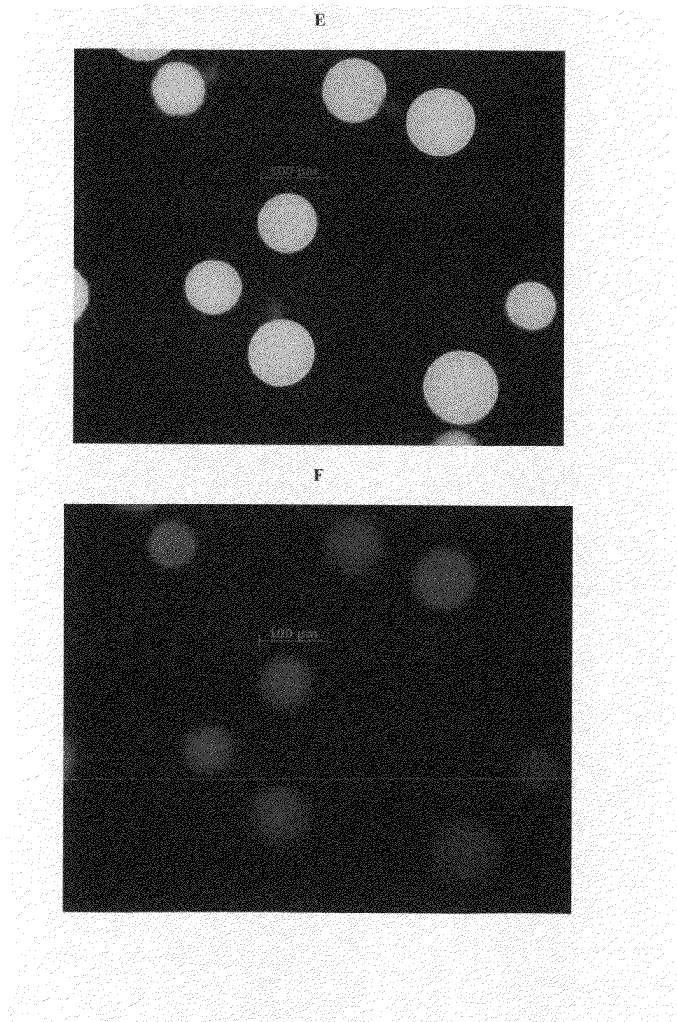

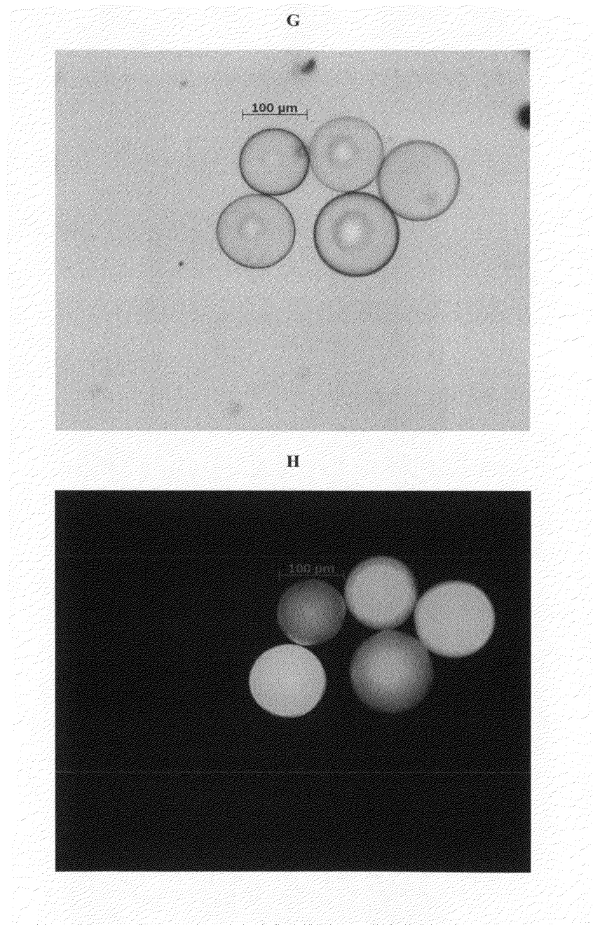

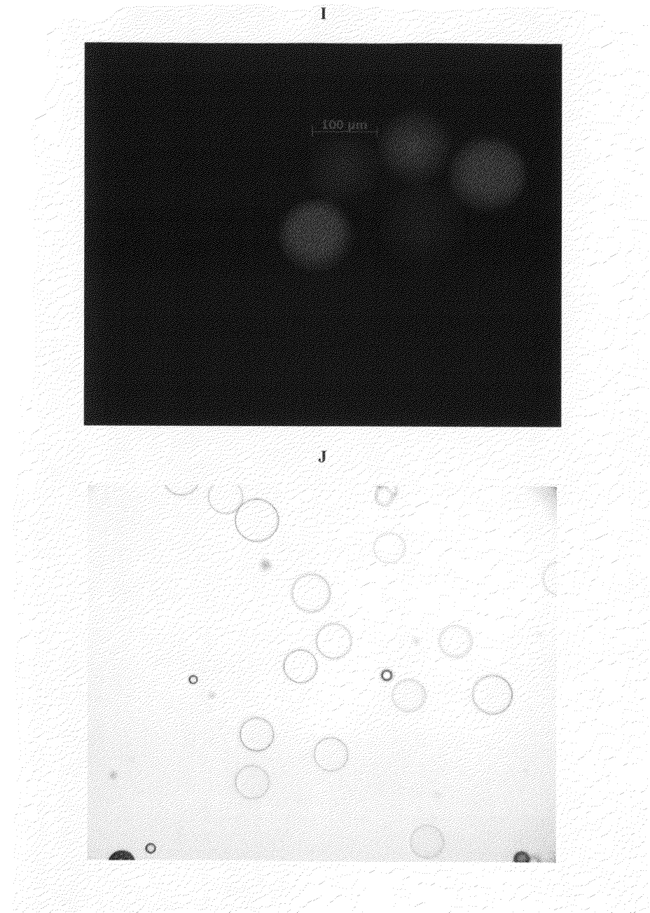

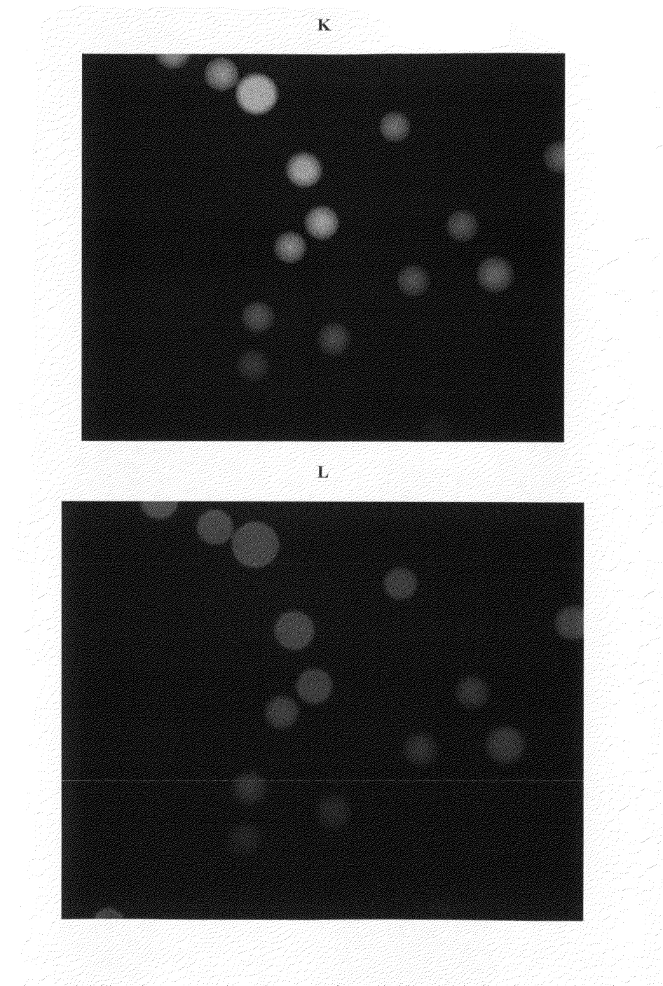

Intermediate diameter and/or thinner shell impermeable polymer microcapsules can also be produced using an alternative Polymer Shell Solution, blending PEGDMA 200 with PEGDA (poly(ethylene glycol) diacrylate of different chain lengths (PEGDA575—Mₙ ˜575 or PEGDA700—Mₙ ˜700—Sigma-Aldrich, St. Louis, Mo.) in the ratio of 4:1 PEGDMA 200:PEGDAXXX and by adjusting the relative flow rates of the three solutions The Core Solution is composed of a low molecular weight fluorescent marker (sodium fluorescein M_{w}=376 Da) and a high molecular weight marker (rhodamine B isothiocyanate-labeled dextran M_{w}=10 kDa) loaded together into the microcapsules in approximately equimolar amounts using the following composition: sodium fluorescein (0.26 mg/mL—Fluka/Sigma-Aldrich, St. Louis, Mo.) and rhodamine B isothiocyanate-dextran (5 mg/mL—Sigma-Aldrich, St. Louis, Mo.) and glycerol (25% v/v—Sigma, St. Louis, Mo.) in distilled water. Intermediate size microcapsules measuring ˜50 μm in diameter were produced using PEDGA575 with the following flow rates: Core Solution—0.05 ml min⁻¹, Polymer Shell Solution—0.010 ml min⁻¹, and Focusing Fluid—15 ml min⁻¹. The resulting microcapsules are shown in FIG. 4A-C. Progressively thinner polymer shells were produced using PEGDA700 by reducing the Polymer Shell Solution flow rate from 0.10 (FIGS. 4D-F) to 0.08 (FIGS. 4G-I) to 0.05 ml min⁻¹ (FIGS. 4J-L) while keeping the Core Solution and Focusing Fluid flow rates constant at 0.10 ml min⁻¹ and 6.5 ml min⁻¹ respectively.

### Example 4

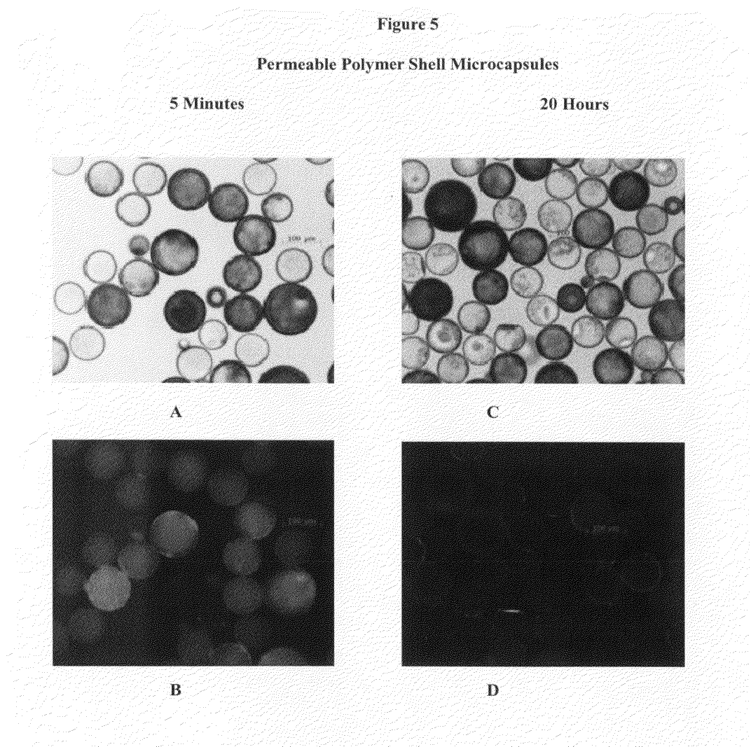

Permeable microcapsules are generated under identical conditions to Example 1 except for the addition of 5% v/v acrylic acid (Sigma-Aldrich, St. Louis, Mo.) to the Polymer Shell Solution as shown in FIGS. 5A-D. Encapsulation efficiency, microcapsule diameter and shell thickness are identical to the impermeable microcapsules, but display a darker and rougher appearance. Microcapsules imaged 5 minutes after formation display fluorescein content similar to that of the impermeable capsules, but when imaged after 20 hour incubation in distilled water at room temperature, the microcapsules have lost most of their fluorescein content while retaining their intact shell morphology, providing evidence of their permeability to fluorescein (M_{R} 376).

### Example 5

Semi-permeability of the polymer shell of the microcapsules as produced in Example 4 was demonstrated by comparing the relative loss/retention of a low molecular weight fluorescent marker (sodium fluorescein M_{w}=376 Da) and a high molecular weight marker (rhodamine B isothiocyanate-labeled dextran M_{w}=10 kDa) loaded together into the semi-permeable microcapsules in approximately equimolar amounts as described in Example 3. All conditions were identical to those in Example 4, except for the composition of the Core Solution, which was modified as follows: sodium fluorescein (0.26 mg/mL—Fluka/Sigma-Aldrich, St. Louis, Mo.) and rhodamine B isothiocyanate-dextran (5 mg/mL—Sigma-Aldrich, St. Louis, Mo.) and glycerol (25% v/v—Sigma, St. Louis, Mo.) in distilled water. Impermeable micorcapsules were prepared as controls using conditions identical to those provided in Example 1 with the Core Solution detailed above.

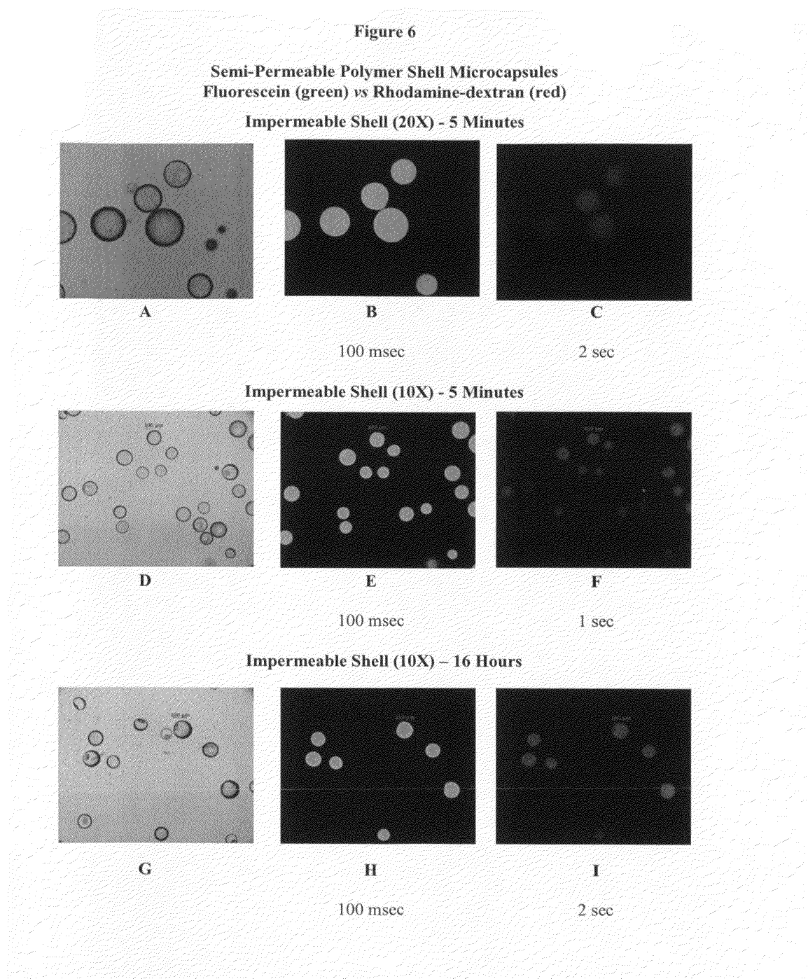

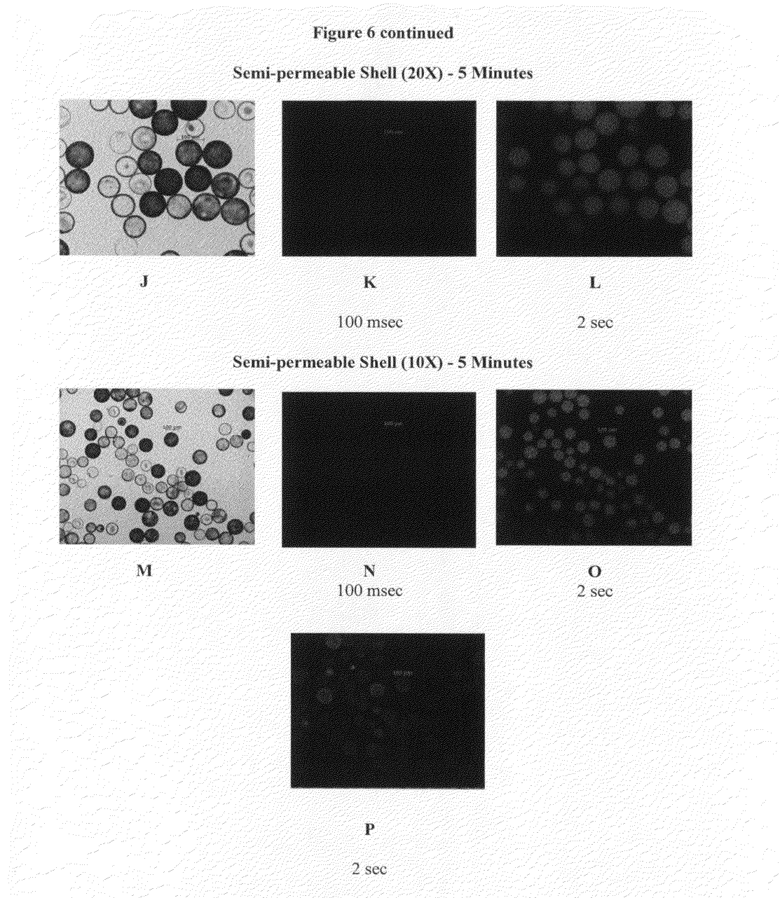

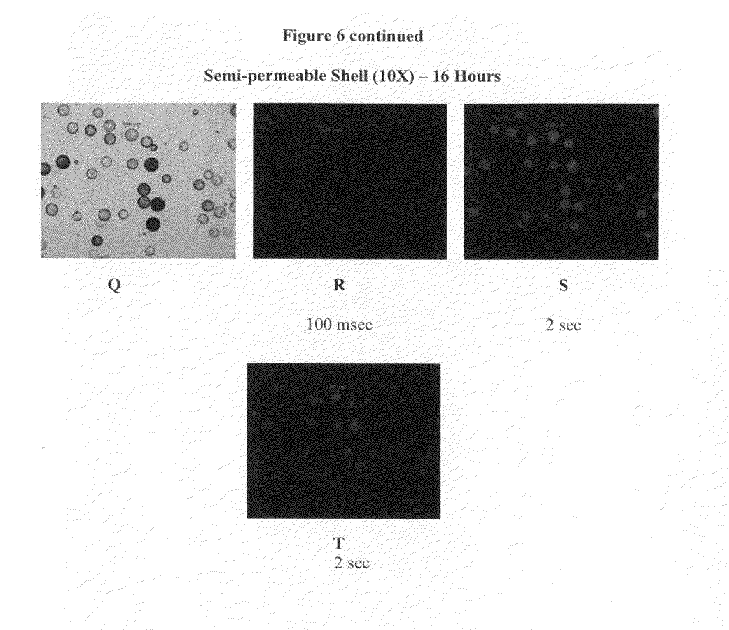

The harvested microcapsules were imaged directly in Focusing Fluid without washing ˜5 minutes after they were created. The microcapsules were then stored at room temperature in Focusing Fluid for ˜16 hours and reimaged. Brightfield and fluorescence images are provided in FIG. 6 below. Exposure times are indicated below each fluorescent image.

There was substantial loss of fluorescein within 5 minutes from the semi-permeable capsules compared with the impermeable control microcapsules, while there was no obvious loss of the rhodamine-labeled dextran even after 16 hours in the semi-permeable microcapsules, indicating that these microcapsules were preferentially permeable to the lower molecular weight fluorescein while retaining the higher molecular weight rhodamine-labeled dextran polymer. The Molecular Weight Cut Off (MWCO) of the semipermeable polymer shell membrane of these microcapsules is therefore >400 Daltons but <10,000 Daltons.

### Example 6

Altered permeability characteristics of polymer shell microcapsules were demonstrated as described in Example 2 using an alternative Polymer Shell formulation. All conditions were identical, except for the composition of the Core Solution, which was modified as follows: fluorescein isothiocyanate-dextran (2 mg/mL—Fluka/Sigma-Aldrich, St. Louis, Mo.) and rhodamine B isothiocyanate-dextran (5 mg/mL—Sigma-Aldrich, St. Louis, Mo.) and glycerol (25% v/v—Sigma, St. Louis, Mo.) in distilled water, and the Polymer Shell Solution, which was modified as follows: 2:1 v/v PEGDMA 200 and MPEOEA (methoxypoly(ethyleneoxy) ethyl acrylate) (Monomer-Polymer & Dajak Labs, Inc., Feasterville, Pa.).

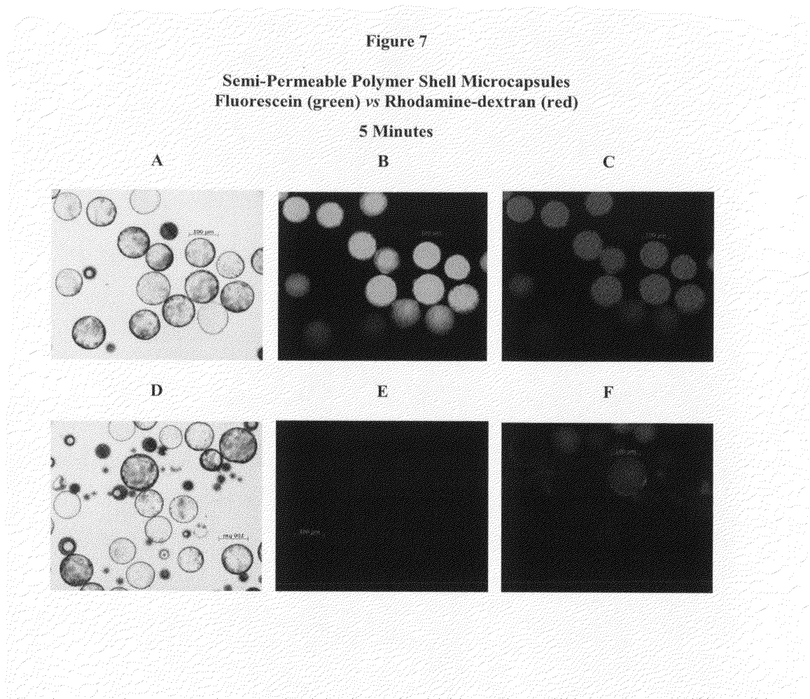

The harvested microcapsules were imaged directly in Focusing Fluid without washing ˜5 minutes after they were created. The microcapsules were then stored in the dark at room temperature in Focusing Fluid for ˜24 hours and reimaged. Brightfield and fluorescence images are provided in FIG. 7. Exposure times are indicated below each fluorescent image.

There was no significant loss of either fluorescent signal from the permeable capsules within 5 minutes compared with the impermeable control microcapsules. However, at t=24 hrs, both signals had decreased significantly with this polymer shell formulation. The Molecular Weight Cut Off (MWCO) of the permeable polymer shell membrane of these microcapsules is therefore >10,000 Daltons.

### Example 7

Semi-permeability of the polymer shells of the microcapsules was further demonstrated by encapsulation of high molecular weight DNA (single-stranded M13mp18 DNA—M_{w} 2.4 MDa, 7,249 bases) in the microcapsules and then labeling the DNA inside the microcapsules by incubating them in an exogenously added, low molecular weight fluorescent dye specific for single-stranded DNA (OliGreen®, M_{w}<1,000 Da—Invitrogen/Molecular Probes, Eugene, Oreg.). Semi-permeable microcapsules were produced as described in Example 5. All conditions were identical, except for the composition of the Core Solution, which was modified as follows: single-stranded M13mp18 DNA (20 μg/mL—Sigma-Aldrich, St. Louis, Mo.) in 1×TE buffer (10 mM Tris (TRIZMA®—tris(hydroxymethyl)aminomethane hydrochloride—Sigma-Aldrich, St. Louis, Mo.), 1 mM EDTA (ethylenediamenetetraacidic acid—Sigma-Aldrich, St. Louis, Mo.), pH 8.1) containing glycerol (25% v/v—Sigma-Aldrich, St. Louis, Mo.), and the Polymer Shell Solution, which was modified as follows: 10:1 v/v PEGDMA 200 and MPEOEA (methoxypoly(ethyleneoxy) ethyl acrylate) (Monomer-Polymer & Dajak Labs, Inc., Feasterville, Pa.). Negative control microcapsules were made with a Core Solutions containing only TE buffer and glycerin.

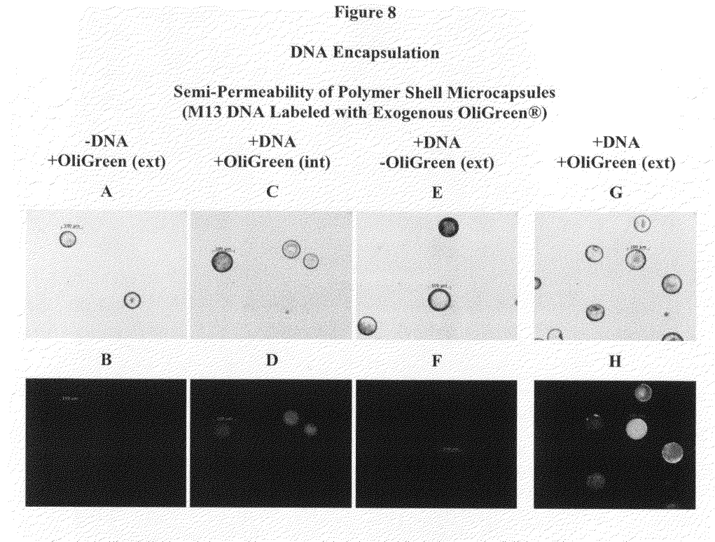

The harvested microcapsules were decanted and rinsed 2× with 20 mL distilled water. Negative control microcapsules without DNA and microcapsules containing the DNA Core Solution were incubated by mixing 100 μL of microcapsule suspension with 40 μL of a 1:20 dilution of OliGreen® in TE buffer. Fluorescence images were taken after 1 hour of incubation in the dark at room temperature, and are provided in FIG. 8. Exposure time for all images: t=5 secs.

There was no observable fluorescence from OliGreen® when added exogenously to negative control microcapsules without DNA. Microcapsules containing 20 μg/mL of single-stranded M13 DNA were brightly stained after incubation for 1 hour in exogenously added OliGreen®, indicating that these microcapsules were preferentially permeable to the lower molecular weight OliGreen® dye while retaining the much higher molecular weight single-stranded M13 DNA. The Molecular Weight Cut Off (MWCO) of the semi-permeable polymer shell membrane of these microcapsules is therefore >1,000 Daltons but <2.4 million Daltons.

### Example 8

DNA amplification in semi-permeable polymer shell microcapsules was demonstrated using hyperbranched Rolling Circle Amplification (RCA). High molecular weight DNA (single-stranded M13mp18 DNA—M_{w} 2.4 MDa, 7,249 bases) was incorporated in microcapsules along with φ29 polymerase, random hexamers as primers, and deoxynucleotide triphosphate mix (dNTP mix). Semi-permeable microcapsules were produced as described in Example 4. All conditions were identical, except for the composition of the Core Solution, which was modified as follows: RCA Mix formulated by combining 13.5 μL diluted single-stranded M13mp18 DNA (1 μg/mL—Sigma-Aldrich, St. Louis, Mo.), 2.125 μL concentrated φ29 polymerase in buffer (New England Biolabs, Ipswich, Mass.), 8.75 μL random hexamer primers in H₂O (New England Biolabs, Ipswich, Mass.), 8.75 μL glycerol (25% v/v—Sigma-Aldrich, St. Louis, Mo.), 3.75 μL 10×RCA buffer (37 mM TRIS-HCl, 50 mM KCl, 10 mM MgCl₂, 5 mM NH₂SO₄, 1 mM DTT (dithiothrietol), 1×BSA), 0.4 μL 10×BSA (bovine serum albumin—New England Biolabs, Ipswich, Mass.) and 3.75 μL dNTP mix (New England Biolabs, Ipswich, Mass.), and the Focusing Fluid, which was composed of 5 wt % PVA in 1×RCA buffer. DNA cannot be visually detected at this low initial concentration in polymer microcapsules.

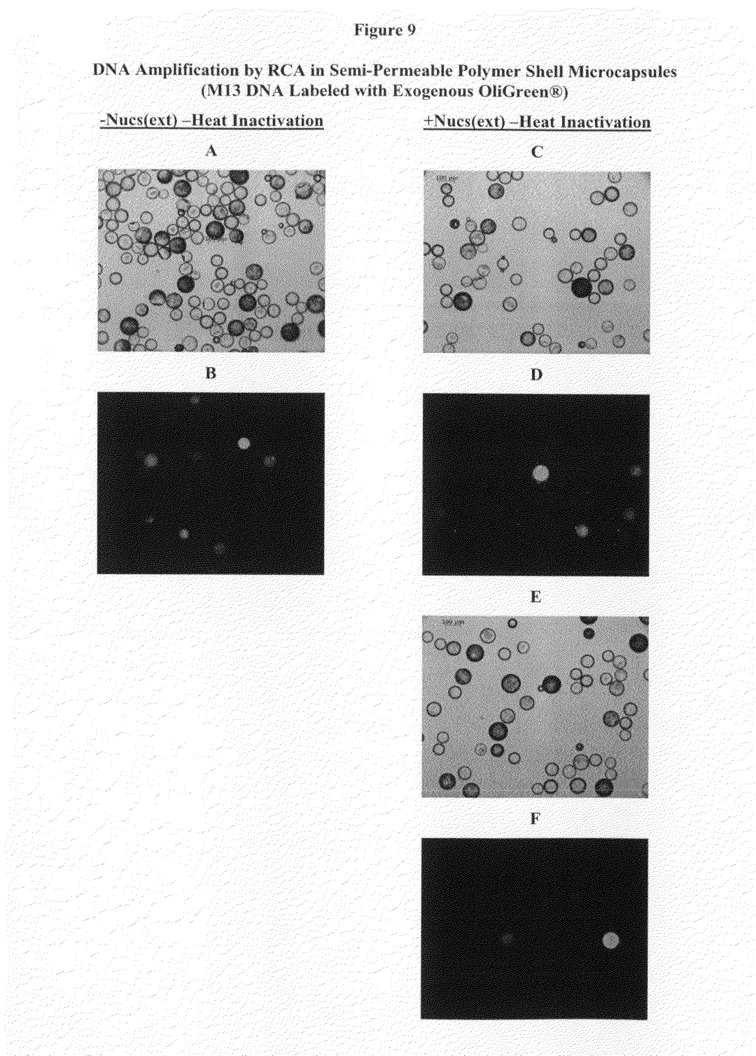

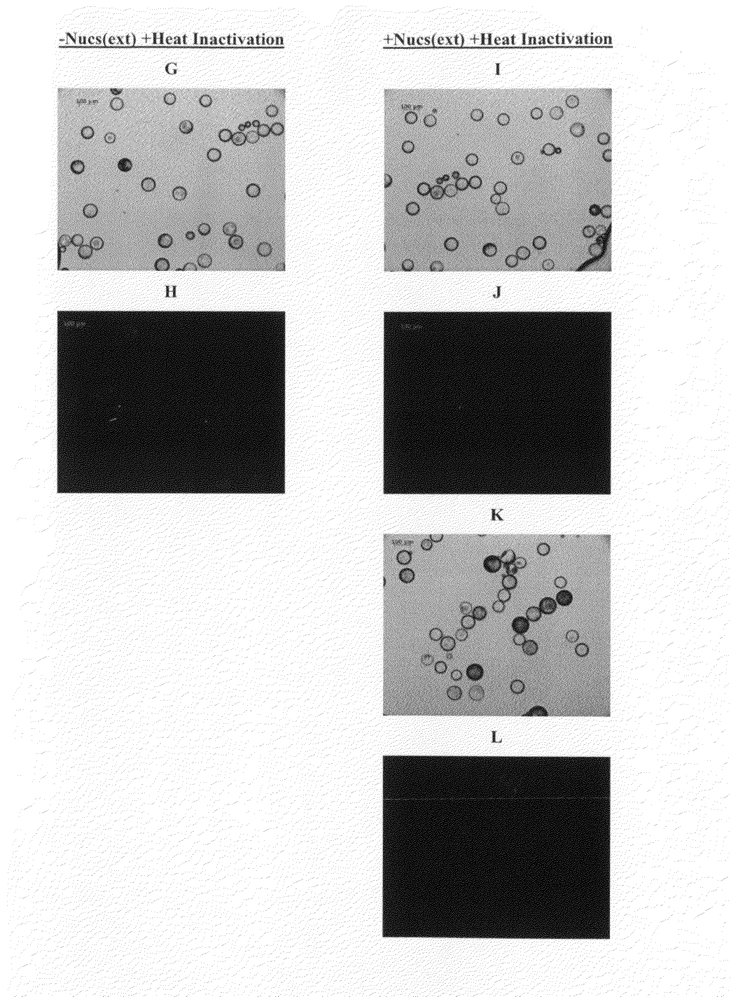

The harvested microcapsules were split into four 100 μL batches in 500 μL Safe-Lock Eppendorf microfuge tubes (Brinkmann Instruments, Inc., Westbury, N.Y.). The first batch was incubated as described below with no further treatment. This polymer microcapsule formulation is known to be permeable to dye molecules that are approximately the same molecular weight as native nucleotides. Therefore, 25 μl dNTP mix was added externally to the second and fourth batches. The third and fourth batches were then subjected to a five minute heat inactivation of the φ29 polymerase at 65° C. The four microfuge tubes containing the microcapsules were incubated at 30° C. for 4 hours in a thermocycler (MiniCycler™—MJ Research, Watertown, Mass.). Following incubation, 100 μL of 2×OliGreenφ reagent (Invitrogen/Molecular Probes, Eugene, Oreg.) in 1×TE was added to each tube, incubated for ˜16 hours at room temperature and then imaged with 4 second exposures. Fluorescence images are provided in FIG. 9.

There was no observable fluorescence from OliGreen® when added exogenously to heat-inactivated control microcapsules, either without exogenously added dNTPs (FIGS. 9G-H) or with exogenously added dNTPs (FIGS. 9I-L). However, microcapsules containing all components necessary to support RCA, either without exogenously added dNTPs (FIGS. 9A-B) or with exogenously added dNTPs (FIGS. 9C-F), demonstrated strong fluorescence from exogenously added OliGreen® providing evidence for significant DNA amplification.

### Example 9

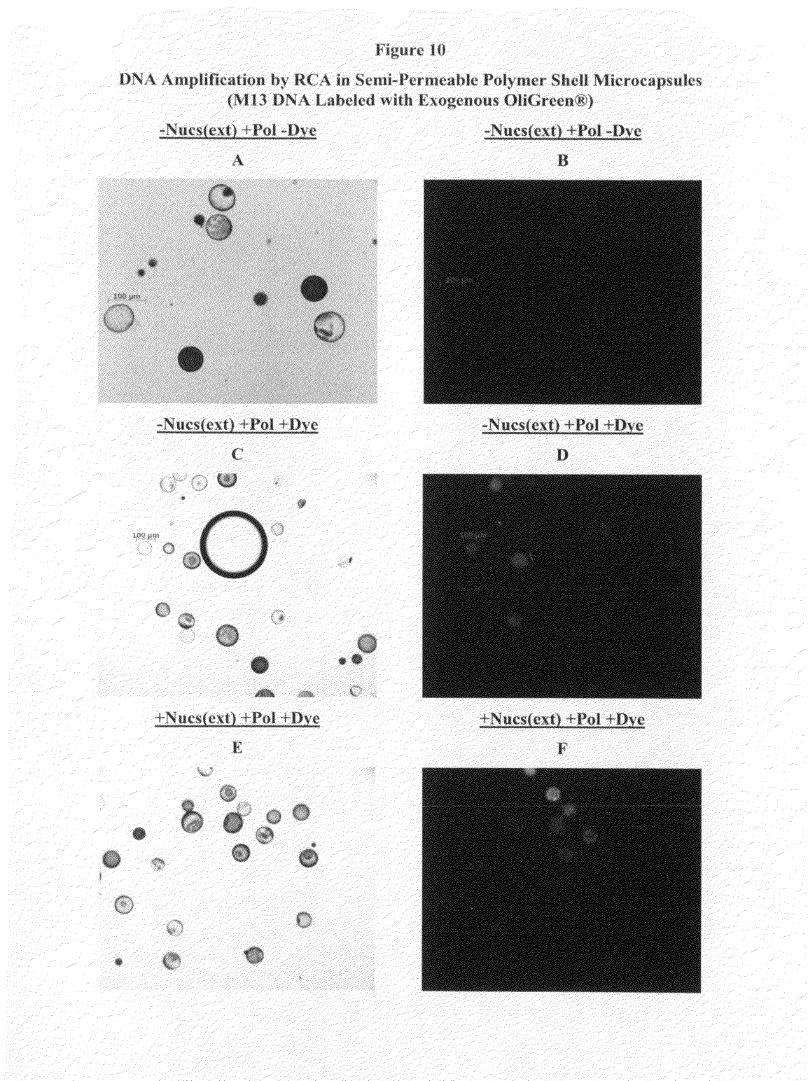

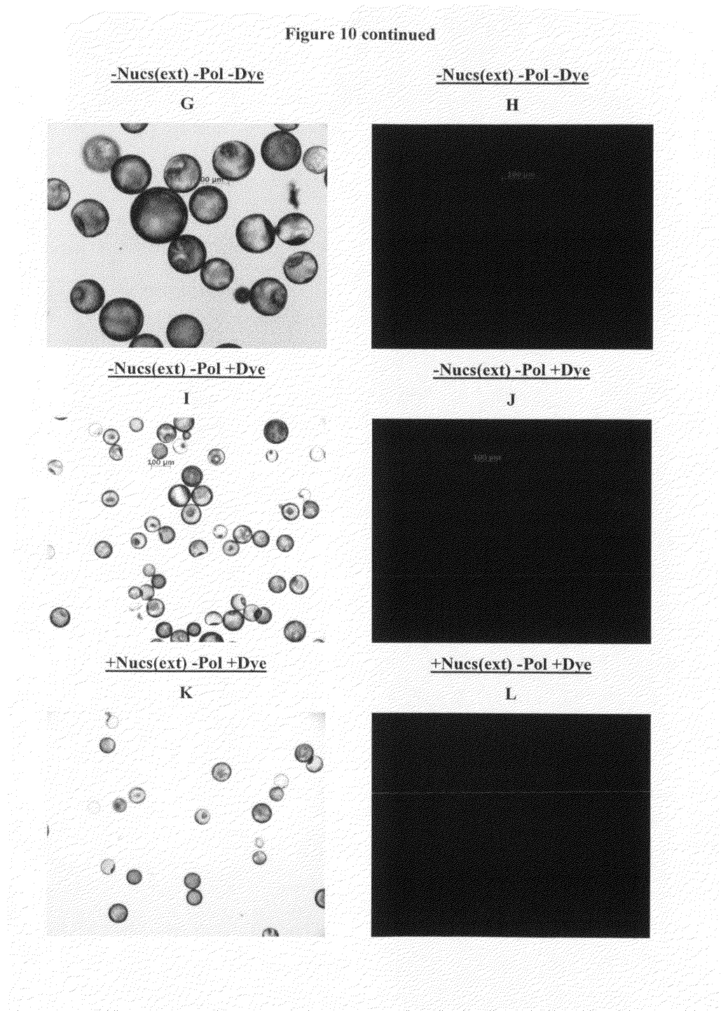

Hyperbranched Rolling Circle Amplification (RCA) was further demonstrated with an alternative polymer shell formulation. Conditions were identical to those in Example 8 except for the composition of the Polymer Shell solution, which was identical to that used in Example 6, except for the ratio of PEGDMA 200 and MPEOEA, which was 10:1 v/v. The microfuge tubes containing the microcapsules were incubated at 35° C. for 10 hours in a thermocycler (MiniCycler™—MJ Research, Watertown, Mass.). Following incubation, 60 μL of 1:20 dilution of OliGreen® reagent (Invitrogen/Molecular Probes, Eugene, Oreg.) in 1×TE was added to each tube, incubated for ˜3 hours at room temperature and then imaged (exposure time=3 sec). Brightfield and fluorescence images are shown in FIG. 10. All control microcapsules lacking polymerase were negative for amplification (G-L). Microcapsules with only internally added nucleotides (C-D), as well as those with both internally and externally added nucleotides (E-F), both show clear evidence of DNA amplification, with somewhat higher integrated fluorescence intensity in the latter batch indicating a higher degree of amplification.

### Example 10

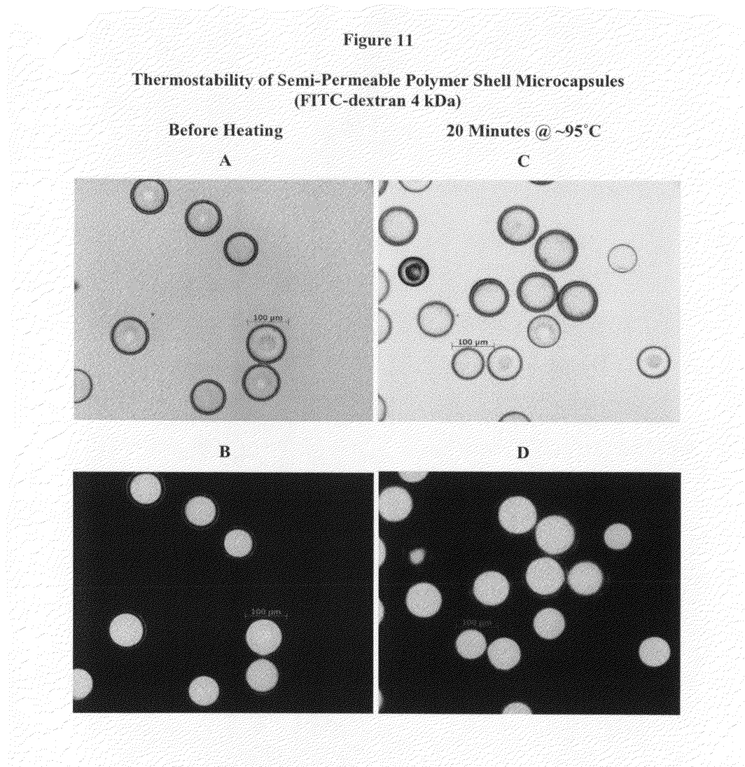

Thermostability of semi-permeable polymer shell microcapsules was demonstrated by producing FITC-labeled dextran (4 kDa) loaded microcapsules as described in Example 5. The harvested microcapsules were rinsed in distilled water and imaged ˜5 minutes after they were created. The microcapsules were then heated to ˜95° C. in distilled water for 20 minutes, cooled to room temperature and reimaged. Brightfield and fluorescence images are provided in FIG. 11.

There was no observable loss of fluorescence or change in the morphology of the microcapsules after heating, indicating that they are sufficiently thermostable to withstand conditions for PCR and/or cycle sequencing.

### Example 11

Permeability of the alternative formulation polymer shell microcapsules to dye-labeled dideoxynucleotide terminators was demonstrated using conditions identical to those in Example 7 except for the composition of the Core Solution, which was 25% v/v glycerol. Impermeable microcapsules were used as controls.

5 μL of suspended microcapsules were mixed with 5 μL of dye-labeled dideoxynucleotide terminators (tetramethyl rhodamine-ddTTP, Thermo Sequenase Dye Terminator Cycle Sequencing Core Kit, Amersham Biosciences, Piscataway, N.J.) and incubated at room temperature in the dark for 3 hours.

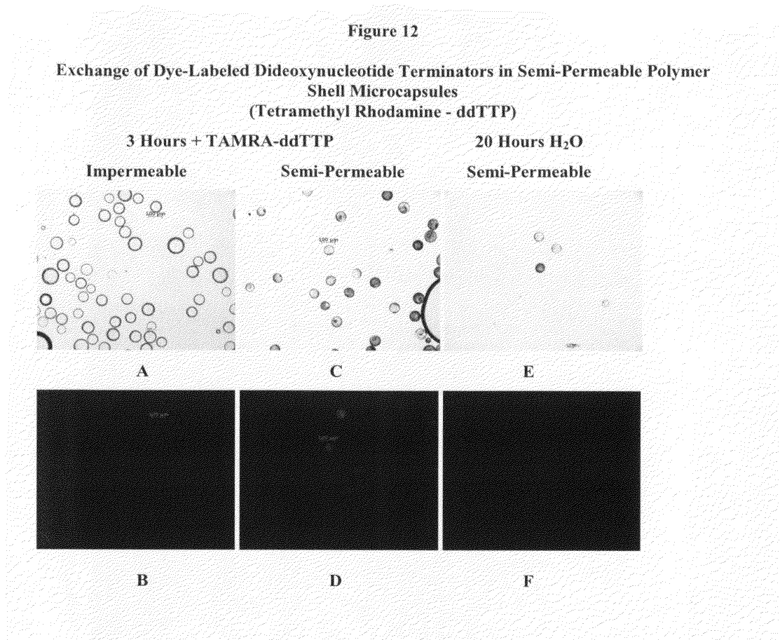

Microcapsules were then washed with 2 mL distilled H₂O and imaged immediately. Microcapsules were allowed to incubate in distilled H2O for an additional 20 hours in the dark and imaged again as shown in FIG. 12.

The aqueous cores of the impermeable PEGDMA microcapsules were non-fluorescent after 3-hour incubation in dye-labeled ddTTP, whereas the aqueous cores of the semi-permeable PEGDMA-MPEOEA microcapsules show significant internal fluorescence. The process is reversible, as indicated by the loss of internal fluorescence upon further incubation in water, indicating that dye-labeled dideoxynucleotide terminators can freely exchange across the semi-permeable polymer shell membrane of these microcapsules.

What is claimed is:

1. A continuous electrophoresis system comprising:
a conveyance apparatus for conveying a base film along a conveying path;
a coating apparatus that applies a first polymer matrix to the base film to form an electrophoresis gel, wherein the first polymer matrix includes microcapsules comprising nucleic acids along an edge of the gel layer;
a buffer reservoir connected to the conveyance apparatus comprising at least one anode, and at least one cathode, wherein the buffer reservoir is configured such that a running buffer is in fluid contact with edges of the electrophoresis gel being conveyed along the conveying path through the buffer reservoir; and
a detection device connected to the conveyance apparatus to record an electropherogram from the electrophoresis gel being conveyed along the conveying path.

2. The system according to claim 1, wherein the coating apparatus is a slide or cascade coating apparatus.

3. The system of claim 1, wherein the coating apparatus comprises a first horizontally oriented roller and a second counter-rotating horizontally oriented roller, wherein the first and second rollers are configured such that a slot is formed between the rollers, wherein the base film is conveyed over the first roller, and wherein the top film is conveyed over the second roller; wherein the apparatus further comprises a distribution channel connected to a reservoir, a pump that dispense the first polymer matrix into the slot between the base film and the top film on the rollers, and an injector that injects the microcapsules along an edge of the first polymer matrix as the first polymer matrix is dispensed.

4. The system of claim 1, wherein the coating apparatus comprises at least three printing apparatuses, wherein a first printing apparatus applies a layer of the first polymer matrix to a top surface of the base film being conveyed along the conveying path to form an electrophoresis gel, a second printing apparatus deposits the microcapsules to the base film, and the third printing apparatus applies a layer of a second polymer matrix over said first polymer matrix.

5. The system according to claim 1, further comprising a UV irradiation device located between the coating apparatus and the buffer reservoir to facilitate polymerization of the first polymer matrix to the base film being conveyed along the conveying path.

6. The system according to claim 1, wherein the system further comprises a temperature control device.

7. The system according to claim 1, further comprising a continuous roll of the base film.

8. The system according to claim 7, wherein each of the base film and the top film is at least one composition selected from polymers or elastomers.

9. The system according to claim 8, wherein the polymer is poly(ethylene terephthalate).

10. The system according to claim 7, wherein the base film is disposable.

11. The system according to claim 7, wherein the base film is reusable.

12. The system according to claim 1, wherein the first polymer matrix is selected from polyacrylamide, poly(N,N-dimethylacrylamide) (pDMA), and agarose.

13. The system according to claim 4, wherein the second polymer matrix is silicone fluid.

14. The system according to claim 1, wherein the detection device is a total internal reflection fluorescence imaging device.

15. The system according to claim 1, wherein the coating apparatus applies a substantially uniform density of the polymer matrix to the base film.

16. The system according to claim 1, wherein the coating apparatus applies a gradient of depth of the polymer matrix to the base film.

17. The system according to claim 1, wherein the coating apparatus applies the polymer matrix to the base film with a depth of about 5 μm.

18. The system according to claim 1, wherein the running buffer is selected from Tris-Borate-EDTA (TBE), Tris-Acetate-EDTA (TAE), Tris-Glycine-Sodium Dodecyl Sulfate (TG-SDS), and Tris-N-(Tris(hydroxymethyl)methyl)3-aminopropanesulfonic acid-EDTA (TTE).

19. A process for parallel DNA sequencing comprising:
applying a layer of a first polymer matrix comprising at least one microcapsule containing nucleic acids to a base film to form an electrophoresis gel being conveyed along a conveying path,
conducting electrophoretic separation of the nucleic acids; and
detecting an electropherogram showing separation of said nucleic acids on the gel.

20. The process according to claim 19, wherein prior to conducting electrophoretic separation, the process further comprises providing a cover to the electrophoresis gel.

21. The process according to claim 22, wherein the cover is selected from the group consisting of a top film or a silicone fluid.

22. The process according to claim 19, wherein the coating apparatus is a slide or cascade coating apparatus.

23. The process according to claim 19, wherein the coating apparatus comprises a first horizontally oriented roller and a second counter-rotating horizontally oriented roller, wherein the first and second rollers are configured such that a slot is formed between the rollers, wherein the base film is conveyed over the first roller, and wherein the top film is conveyed over the second roller; wherein the apparatus further comprises a distribution channel connected to a reservoir, a pump that dispense the first polymer matrix into the slot between the base film and the top film on the rollers, and an injector that injects the microcapsules along an edge of the first polymer matrix as the first polymer matrix is dispensed.

24. The process according to claim 19, wherein the coating apparatus comprises at least three printing apparatuses, wherein a first printing apparatus applies a layer of the first polymer matrix to a top surface of the base film being conveyed along the conveying path to form an electrophoresis gel, a second printing apparatus deposits the microcapsules to the base film, and the third printing apparatus applies a layer of a second polymer matrix over said first polymer matrix.

25. The process according to claim 19, wherein the layer of the first polymer matrix on the base film is a layer of about 5 μm in depth.

26. The process according to claim 19, wherein the base film is at least one composition selected from a polymer and an elastomer.

27. The process according to claim 26, wherein the polymer is poly(ethylene terephthalate).

28. The process according to claim 19, wherein the base film is disposable.

29. The process according to claim 19, wherein the base film is reusable.

30. A method of nucleic acid sequencing, comprising:
conducting a sequencing reaction in a microcapsule;
applying the microcapsule and a first polymer matrix onto a base film to form an electrophoresis gel that is being continuously conveyed along a conveying path;
conducting electrophoretic separation; and
detecting results of the electrophoretic separation, thereby sequencing the nucleic acid.
